(19) United States
(12) Patent Application Publication
(10) Pub. No.: US 2025/0364774 A1
(43) Pub. Date: Nov. 27, 2025

(54) LASER APPARATUS, METHOD OF CONTROLLING LASER APPARATUS, AND METHOD OF MANUFACTURING ELECTRONIC DEVICE

(71) Applicant: Gigaphoton Inc, Oyama-shi (JP)

(72) Inventors: Kazuki NAGAI, Oyama-shi (JP); Yoichi SASAKI, Oyama-shi (JP)

(73) Assignee: Gigaphoton Inc, Oyama-shi (JP)

(21) Appl. No.: 19/292,549

(22) Filed: Aug. 6, 2025

Related U.S. Application Data
(63) Continuation of application No. PCT/JP2023/010462, filed on Mar. 16, 2023.

(51) Int. Cl. H01S 3/134; H01S 3/00; H01S 3/10

(52) U.S. Cl. CPC H01S 3/134; H01S 3/0014; H01S 3/10046

(57) ABSTRACT

A laser apparatus includes a laser chamber, a pair of discharge electrodes, a fan, a rotation detector, an adjuster, and a processor. The discharge electrodes are disposed in the laser chamber. The fan is disposed in the laser chamber and is configured to cause laser gas in the laser chamber to flow between the discharge electrodes. The rotation detector is configured to detect the rotation of the fan. The adjuster is configured to adjust a laser beam characteristic of a pulse laser beam generated in the laser chamber. The processor is configured to correct a control value of the adjuster based on a repetition frequency of the pulse laser beam and a detection signal of the rotation detector and to control the adjuster with the corrected control value.

### CROSS-REFERENCE TO RELATED APPLICATIONS

The present application is a continuation application of International Application No. PCT/JP2023/010462, filed on Mar. 16, 2023, the entire contents of which are hereby incorporated by reference.

### BACKGROUND

### 1. Technical Field

The present disclosure relates to a laser apparatus, a method of controlling the laser apparatus, and a method of manufacturing an electronic device.

### 2. Related Art

Recently, in a semiconductor exposure apparatus, improvement in resolution has been desired for miniaturization and high integration of semiconductor integrated circuits. For this purpose, an exposure light source that outputs light having a shorter wavelength has been developed. For example, as a gas laser apparatus for exposure, a KrF excimer laser apparatus that outputs a laser beam having a wavelength of about 248 nm and an ArF excimer laser apparatus that outputs a laser beam having a wavelength of about 193 nm are used.

Spectral line widths of spontaneous oscillation beams of the KrF excimer laser apparatus and the ArF excimer laser apparatus are as wide as from 350 pm to 400 pm. Thus, chromatic aberration occurs in some cases when a projection lens is made of a material that transmits ultraviolet light such as KrF and ArF laser beams. As a result, the resolution may decrease. Thus, the spectrum line width of a laser beam output from the gas laser apparatus needs to be narrowed until chromatic aberration becomes negligible. Therefore, in a laser resonator of the gas laser apparatus, a line narrowing module (LNM) including a line narrowing element (such as an etalon or a grating) may be provided in order to narrow the spectral line width. A gas laser apparatus with a narrowed spectral line width is referred to as a line narrowing gas laser apparatus.

### LIST OF DOCUMENTS

### Patent Documents

Patent Document 1: Japanese Unexamined Patent Application Publication No. 2006-114689
Patent Document 2: Japanese Unexamined Patent Application Publication No. 2003-218432

### SUMMARY

A laser apparatus according to one aspect of the present disclosure may include a laser chamber, a pair of discharge electrodes, a fan, a rotation detector, an adjuster, and a processor. The discharge electrodes may be disposed in the laser chamber. The fan may be disposed in the laser chamber and be configured to cause laser gas in the laser chamber to flow between the discharge electrodes. The rotation detector may be configured to detect the rotation of the fan. The adjuster may be configured to adjust a laser beam characteristic of a pulse laser beam generated in the laser chamber. The processor may be configured to correct a control value of the adjuster based on a repetition frequency of the pulse laser beam and a detection signal of the rotation detector and to control the adjuster with the corrected control value.

In a method of controlling a laser apparatus according to one aspect of the present disclosure, the laser apparatus may include a laser chamber, a pair of discharge electrodes, a fan, a rotation detector, and an adjuster. The discharge electrodes may be disposed in the laser chamber. The fan may be disposed in the laser chamber and be configured to cause laser gas in the laser chamber to flow between the discharge electrodes. The rotation detector may be configured to detect the rotation of the fan. The adjuster may be configured to adjust a laser beam characteristic of a pulse laser beam generated in the laser chamber. The method may include correcting a control value of the adjuster based on a repetition frequency of the pulse laser beam and a detection signal of the rotation detector, and controlling the adjuster with the corrected control value.

A method of manufacturing an electronic device according to one aspect of the present disclosure may include generating a pulse laser beam with a laser apparatus. The laser apparatus may include a laser chamber, a pair of discharge electrodes, a fan, a rotation detector, an adjuster, and a processor. The discharge electrodes may be disposed in the laser chamber. The fan may be disposed in the laser chamber and be configured to cause laser gas in the laser chamber to flow between the discharge electrodes. The rotation detector may be configured to detect the rotation of the fan. The adjuster may be configured to adjust a laser beam characteristic of a pulse laser beam generated in the laser chamber. The processor may be configured to correct a control value of the adjuster based on a repetition frequency of the pulse laser beam and a detection signal of the rotation detector and to control the adjuster with the corrected control value. The method may further include outputting the pulse laser beam to an exposure apparatus, and exposing a photosensitive substrate to the pulse laser beam in the exposure apparatus to manufacture the electronic device.

### BRIEF DESCRIPTION OF THE DRAWINGS

Embodiments of the present disclosure will be described below merely as examples with reference to the accompanying drawings.

FIG. 1 schematically illustrates the configuration of a laser apparatus according to a comparative example.

FIG. 2 schematically illustrates part of the configuration of the laser apparatus according to the comparative example as viewed in a −V direction.

FIG. 3 schematically illustrates part of the configuration of the laser apparatus according to the comparative example as viewed in a −Z direction.

FIG. 4 schematically illustrates the configuration of a rotation detector.

FIG. 5 shows a disk and a protrusion as viewed in a Z direction.

FIG. 6 is a waveform diagram showing an example of a detection signal output from the rotation detector.

FIG. 7 is a flowchart showing a control procedure of a laser beam characteristic in the comparative example.

FIG. 8 is a graph showing time-series data of the laser beam characteristic in the comparative example.

FIG. 9 is a graph showing the time-series data of the laser beam characteristic in the comparative example.

FIG. 10 is a graph showing a result of fast Fourier transform of the time-series data of the laser beam characteristic shown in FIG. 9.

FIG. 11 is a view for describing acoustic waves generated inside a laser chamber.

FIG. 12 schematically illustrates the configuration of a laser apparatus according to a first embodiment.

FIG. 13 is a graph showing a fluctuation component Bfi1(t) of the laser beam characteristic in the first embodiment.

FIG. 14 shows a first example of data stored in a parameter storage apparatus in the first embodiment.

FIG. 15 shows a second example of data stored in the parameter storage apparatus in the first embodiment.

FIG. 16 is a flowchart showing a control procedure of a laser beam characteristic in the first embodiment.

FIG. 17 is a flowchart showing details of processing of calculating a control value SVb1_{N+1} for the N+1-th pulse.

FIG. 18 is a graph showing time-series data of a laser beam characteristic generated using the corrected control value SVb1_{N+1} in the first embodiment.

FIG. 19 shows expressions and variables that can be replaced when pulse energy, wavelength, or spectral line width is controlled as the laser beam characteristic.

FIG. 20 is a graph showing a difference between the time-series data of the laser beam characteristic and a fluctuation component Bfi1(t).

FIG. 21 is a graph showing a fluctuation component Bfi2(t) in a second embodiment.

FIG. 22 shows a first example of data stored in the parameter storage apparatus in the second embodiment.

FIG. 23 shows a second example of data stored in the parameter storage apparatus in the second embodiment.

FIG. 24 is a flowchart showing a control procedure of a laser beam characteristic in the second embodiment.

FIG. 25 is a flowchart showing details of processing of calculating a control value SVb2_{N+1} for the N+1-th pulse.

FIG. 26 is a graph showing time-series data of a laser beam characteristic generated using the corrected control value SVb2_{N+1} in the second embodiment.

FIG. 27 shows expressions and variables that can be replaced when pulse energy, wavelength, or spectral line width is controlled as a laser beam characteristic.

FIG. 28 schematically shows the configuration of an exposure apparatus connected to the laser apparatus.

### DESCRIPTION OF EMBODIMENTS

### Contents

1. Comparative Example
   1.1 Configuration of Laser Apparatus 1
   1.2 Operation
   1.3 Control of Laser Beam Characteristic B
   1.4 Problems of Comparative Example
2. Estimation of Fluctuation Causes
   2.1 Relationship with Rotational Frequency fk
   2.2 Relationship with Blade Frequency fa
3. Feedforward Control Based on Repetition Frequency f
and Detection Signal SIG
   3.1 Configuration
   3.2 Calculation of Fluctuation Component Bfi1(t)
   3.3 Control of Laser Beam Characteristic B
   3.4 Effects
4. Modifications of First Embodiment
   4.1 First Modification
   4.2 Second Modification
   4.3 Third Modification
   4.4 Fourth Modification
   4.5 Effects of Fourth Modification
5. Feedforward Control Using Blade Frequency fa
   5.1 Calculation of Fluctuation Component Bfi2(t)
   5.2 Control of Laser Beam Characteristic B
   5.3 Effects
6. Modifications of Second Embodiment
   6.1 First Modification
   6.2 Second Modification
   6.3 Third Modification
   6.4 Fourth modification
7. Others

Hereinafter, embodiments of the present disclosure will be described in detail with reference to the drawings. The embodiments described below show some examples of the present disclosure and do not limit contents of the present disclosure. Not all configurations and operations described in each embodiment are necessarily essential as configurations and operations of the present disclosure. Here, the same components are denoted by the same reference numerals, and any redundant description thereof is omitted.

### 1. Comparative Example

### 1.1. Configuration of Laser Apparatus 1

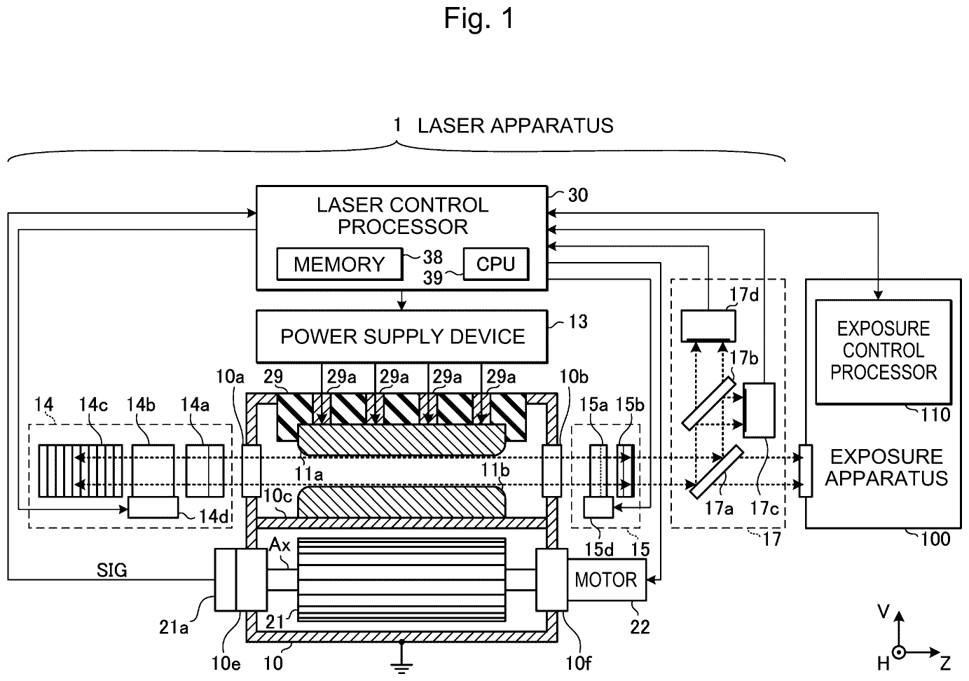

FIG. 1 schematically illustrates the configuration of a laser apparatus 1 according to a comparative example. The comparative example of the present disclosure is an example recognized by the applicant as known only by the applicant, and is not a publicly known example admitted by the applicant. The laser apparatus 1 is a discharge-excited gas laser apparatus capable of outputting pulse laser beam to an exposure apparatus 100. The exposure apparatus 100 includes an exposure control processor 110.

The laser apparatus 1 includes a laser chamber 10, a pair of discharge electrodes 11a and 11b, a power supply device 13, a line narrowing module 14, a spectral adjuster 15, a monitor module 17, and a laser control processor 30. The line narrowing module 14 and the spectral adjuster 15 constitute an optical resonator. The laser chamber 10 is disposed on an optical path of the optical resonator. The laser control processor 30 is a processing device including a memory 38 in which a control program is stored and a central processing unit (CPU) 39 configured to execute the control program. The laser control processor 30 is specially configured or programmed to execute various kinds of processing included in the present disclosure. The laser control processor 30 corresponds to a processor in the present disclosure.

The propagation direction of the pulse laser beam output from the spectral adjuster 15 is a Z direction. The discharge direction between the discharge electrodes 11a and 11b is a V direction or a −V direction. The Z direction and the V direction are directions perpendicular to each other, and the direction perpendicular to both of those directions is an H direction or a −H direction. In FIG. 1, the configuration of the laser apparatus 1 as viewed in the −H direction is shown.

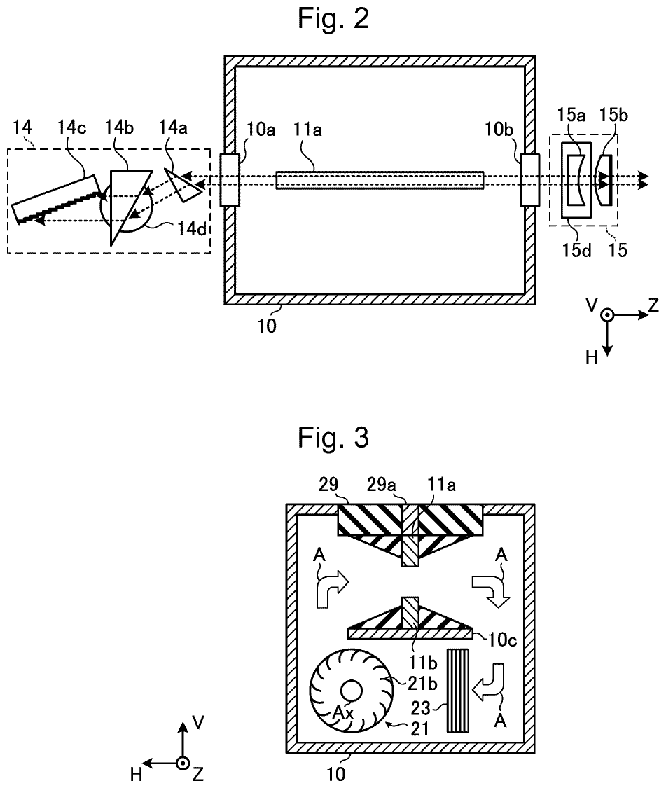

FIG. 2 shows part of the configuration of the laser apparatus 1 according to the comparative example as viewed in the −V direction, and FIG. 3 shows part of the configuration of the laser apparatus 1 according to the comparative example as viewed in the −Z direction.

The laser chamber 10 houses the discharge electrodes 11a and 11b, a crossflow fan 21, and a heat exchanger 23. In FIG. 2, only the discharge electrode 11a is shown as the internal configuration of the laser chamber 10. Windows 10a and 10b are provided at respective ends of the laser chamber 10.

Laser gas containing, for example, argon gas or krypton gas as rare gas, fluorine gas as halogen gas, and neon gas as buffer gas is encapsulated in the laser chamber 10. Alternatively, laser gas containing fluorine gas and buffer gas may be encapsulated.

An opening is formed in part of the laser chamber 10, and the opening is sealed by an electrical insulation part 29. The electrical insulation part 29 supports the discharge electrode 11a. A plurality of conductive parts 29a are embedded in the electrical insulation part 29. Each of the conductive parts 29a is electrically connected to the discharge electrode 11a. The power supply device 13 includes a non-illustrated charger and is connected to the discharge electrode 11a via the conductive parts 29a.

A return plate 10c is disposed inside the laser chamber 10. The discharge electrode 11b is supported by the return plate 10c. The discharge electrode 11b is electrically connected to a ground potential via the return plate 10c and an electrically conductive member of the laser chamber 10. As shown in FIG. 3, the return plate 10c has a gap for the laser gas to pass through on both the depth side and the near side of the plane of paper of FIG. 1.

The crossflow fan 21 includes a plurality of blades 21b arranged around a rotation shaft Ax. One end of the rotation shaft Ax is supported by a bearing 10e and is connected to a rotation detector 21a disposed outside the laser chamber 10. The other end of the rotation shaft Ax is supported by a bearing 10f and is connected to a motor 22 disposed outside the laser chamber 10. The crossflow fan 21 corresponds to a fan in the present disclosure.

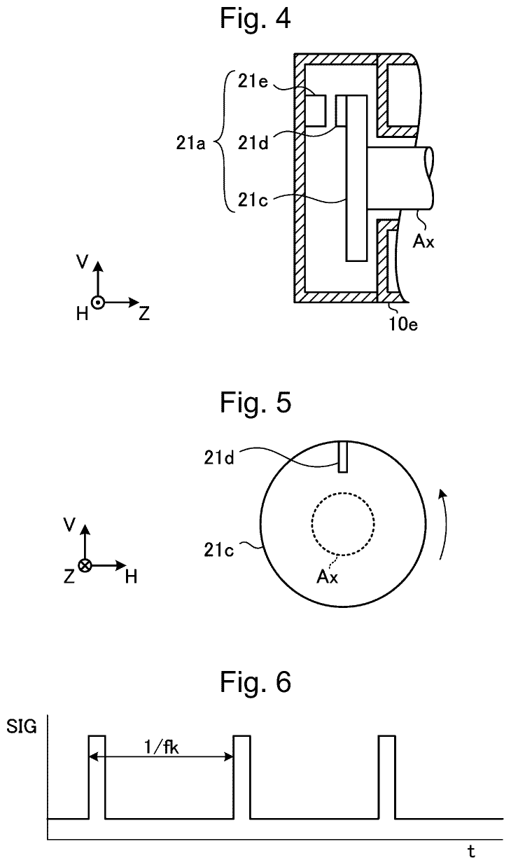

FIG. 4 schematically shows the configuration of the rotation detector 21a. The rotation detector 21a is disposed inside a housing fixed to the bearing 10e and includes a disk 21c supported at one end of the rotation shaft Ax and an eddy current sensor 21e fixed to the bearing 10e through the housing. The disk 21c is made of metal and includes a projection 21d.

FIG. 5 shows the disk 21c and the projection 21d as viewed in the Z direction. The disk 21c and the projection 21d rotate together with the rotation shaft Ax. The eddy current sensor 21e generates a first pulse magnetic field. When the projection 21d passes near the eddy current sensor 21e, an eddy current due to the first pulse magnetic field is generated inside the projection 21d. The eddy current sensor 21e detects a second pulse magnetic field generated by the eddy current and outputs a detection signal SIG. A capacitive sensor may be used instead of the eddy current sensor 21e.

FIG. 6 is a waveform diagram showing an example of the detection signal SIG output from the rotation detector 21a. The detection signal SIG of one pulse is output each time the rotation shaft Ax completes one rotation. The repetition frequency of the detection signal SIG matches a rotation frequency fk of the crossflow fan 21, and the period of the detection signal SIG is 1/fk. The detection signal SIG is transmitted to the laser control processor 30.

Referring back to FIG. 1 and FIG. 2, the line narrowing module 14 includes a plurality of prisms 14a and 14b and a grating 14c. The prisms 14a and 14b are disposed in the stated order on the optical path of light output through the window 10a. Surfaces of the prisms 14a and 14b through which light enters and exits are both parallel to the V direction. The prism 14b is supported by a rotation stage 14d. The rotation stage 14d includes a non-illustrated driver. The grating 14c is disposed on the optical path of the light that has passed through the prisms 14a and 14b. The direction of grooves of the grating 14c is parallel to the V direction.

The spectral adjuster 15 includes a cylindrical planoconcave lens 15a and a cylindrical planoconvex lens 15b. The cylindrical planoconcave lens 15a is positioned between the laser chamber 10 and the cylindrical planoconvex lens 15b. The convex surface of the cylindrical planoconvex lens 15b and the concave surface of the cylindrical planoconcave lens 15a face each other and have focal axes parallel to the V direction. A flat surface positioned on the side opposite the convex surface of the cylindrical planoconvex lens 15b is coated with a partially reflective film. The cylindrical planoconcave lens 15a is supported by a linear stage 15d. The linear stage 15d includes a non-illustrated driver.

The monitor module 17 includes beam splitters 17a and 17b, an energy sensor 17c, and a beam monitor 17d. The beam splitter 17a is positioned on the optical path of the pulse laser beam output from the spectral adjuster 15. The beam splitter 17a is configured to transmit part of the pulse laser beam toward the exposure apparatus 100 at high transmittance and to reflect the other part. The beam splitter 17b is positioned on the optical path of the pulse laser beam reflected by the beam splitter 17a. The energy sensor 17c is positioned on the optical path of the pulse laser beam reflected by the beam splitter 17b. The beam monitor 17d is positioned on the optical path of the pulse laser beam that has passed through the beam splitter 17b. The beam monitor 17d includes a non-illustrated etalon spectrometer. The monitor module 17 corresponds to a laser beam detector in the present disclosure.

### 1.2 Operation

The laser control processor 30 receives setting data for target values Et, λt, and Δλt of pulse energy E, wavelength λ, and spectral line width Δλ, respectively, from the exposure control processor 110 along with a light emission trigger signal.

The laser control processor 30 transmits setting data for the charging voltage to the charger included in the power supply device 13 based on the setting data of the target value Et of the pulse energy E. The laser control processor 30 transmits a trigger signal to the power supply device 13 based on the light emission trigger signal.

When the power supply device 13 receives the trigger signal from the laser control processor 30, the power supply device 13 generates pulsed high voltage from electric energy charged in the charger and applies this high voltage between the discharge electrodes 11a and 11b.

When the high voltage is applied between the discharge electrodes 11a and 11b, discharge occurs between the discharge electrodes 11a and 11b. A laser medium in the laser chamber 10 is excited by energy of the discharge and transitions to a higher energy level. When the excited laser medium transitions to a lower energy level thereafter, the excited laser medium outputs light having a wavelength in accordance with the difference between the energy levels.

The light generated in the laser chamber 10 is output to the outside of the laser chamber 10 through the windows 10a and 10b. The beam width in the H direction of the light output from the window 10a of the laser chamber 10 is expanded through the prisms 14a and 14b and the light is incident on the grating 14c.

The light incident on the grating 14c is reflected by a plurality of grooves of the grating 14c and is diffracted in a direction in accordance with the wavelength of the light. By matching the incident angle of the light that is incident on the grating 14c and the diffraction angle of diffracted light having a desired wavelength with each other, the wavelength of the diffracted light to be incident on the prism 14b from the grating 14c is selected. The prisms 14a and 14b reduce the beam width in the H direction of the incident diffracted light from the grating 14c and return the light to the laser chamber 10 through the window 10a.

The cylindrical planoconvex lens 15b included in the spectral adjuster 15 transmits and outputs part of the light output from the window 10b of the laser chamber 10 and reflects the other part back into the laser chamber 10.

In this manner, light output from the laser chamber 10 reciprocates between the line narrowing module 14 and the spectral adjuster 15 and is amplified each time the light passes through a discharge space between the discharge electrodes 11a and 11b. The light is subjected to line narrowing each time the light is returned from the line narrowing module 14. The light subjected to laser oscillation and line narrowing in this manner is output as a pulse laser beam from the spectral adjuster 15.

The laser control processor 30 transmits a control signal of the rotation angle of the prism 14b to the rotation stage 14d included in the line narrowing module 14 based on the setting data of the target value λt of the wavelength λ. The rotation stage 14d rotates the prism 14b around an axis parallel to the V direction in accordance with the control signal. By rotating the prism 14b, the selected wavelength of the line narrowing module 14 is adjusted, and the wavelength λ of the pulse laser beam is adjusted. The wavelength λ of the pulse laser beam is a center wavelength, for example.

The laser control processor 30 transmits a control signal of the position of the cylindrical planoconcave lens 15a to the linear stage 15d included in the spectral adjuster 15 based on the setting data of the target value Δλt of the spectral line width Δλ. The linear stage 15d moves the cylindrical planoconcave lens 15a along the optical path between the laser chamber 10 and the cylindrical planoconvex lens 15b in accordance with the control signal. According to this, the wavefront of light from the spectral adjuster 15 toward the line narrowing module 14 changes. As the wavefront changes, the spectrum waveform and the spectral line width Δλ of the pulse laser beam are adjusted.

The energy sensor 17c detects the pulse energy E of the pulse laser beam and outputs data of the pulse energy E to the laser control processor 30. The data of the pulse energy E is used by the laser control processor 30 to perform feedback control of the setting data of the charging voltage transmitted to the power supply device 13.

The etalon spectrometer included in the beam monitor 17d acquires the waveform of interference fringes of the pulse laser beam and outputs waveform data of the interference fringes to the laser control processor 30. The laser control processor 30 calculates the wavelength λ of the pulse laser beam from the position of the interference fringes and calculates the spectral line width Δλ of the pulse laser beam from a portion of the waveform corresponding to the free spectral range out of the waveform of the interference fringes. The calculation result of the wavelength λ is used by the laser control processor 30 to perform feedback control of the rotation angle of the prism 14b, and the calculation result of the spectral line width Δλ is used by the laser control processor 30 to perform feedback control of the position of the cylindrical planoconcave lens 15a.

The laser control processor 30 transmits a control signal to the motor 22 in order to rotate the crossflow fan 21. When the motor 22 rotates the crossflow fan 21, laser gas flows and circulates inside the laser chamber 10 as indicated by arrows A in FIG. 3. Discharge products generated by the discharge between the discharge electrodes 11a and 11b are removed from the discharge space by the flow of the laser gas before the next discharge, and the discharge space and its vicinity become a state with few discharge products. Therefore, the discharge can be stabilized. The rotation detector 21a detects the rotation of the crossflow fan 21 and outputs the detection signal SIG to the laser control processor 30. The heat exchanger 23 exhausts the thermal energy of the laser gas whose temperature has become high due to the discharge to the outside of the laser chamber 10.

### 1.3 Control of Laser Beam Characteristic B

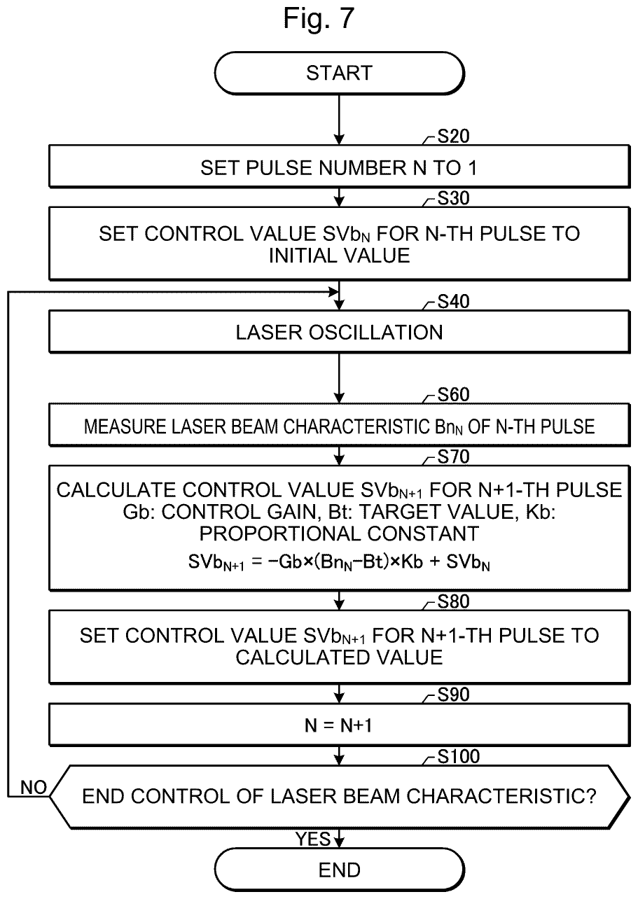

FIG. 7 is a flowchart showing a control procedure of a laser beam characteristic B in the comparative example. The laser beam characteristic B is any of the pulse energy E, the wavelength λ, and the spectral line width Δλ, for example. The laser control processor 30 performs feedback control of the laser beam characteristic B by carrying out the following processing.

In S20, the laser control processor 30 sets a pulse number N of the pulse laser beam to 1.

In S30, the laser control processor 30 sets a control value SVb_{N} for the N-th pulse to an initial value. When the laser beam characteristic B is the pulse energy E, a control value SVb is the charging voltage set for the power supply device 13. When the laser beam characteristic B is the wavelength λ, the control value SVb is the posture angle of the prism 14b that is rotated by the rotation stage 14d. When the laser beam characteristic B is the spectral line width Δλ, the control value SVb is the position of the cylindrical planoconcave lens 15a that is moved by the linear stage 15d. When the pulse number such as the N-th number is specified, a subscript is added as in the control value SVb_{N}. The initial value is a value that is preset in correspondence to a target value Bt of the laser beam characteristic B, for example.

In S40, the laser control processor 30 transmits a trigger signal to the power supply device 13 such that one pulse of the pulse laser beam is output by laser oscillation.

In S60, the laser control processor 30 measures a laser beam characteristic Bn_{N} of the N-th pulse.

In S70, the laser control processor 30 calculates a control value SVb_{N+1} for the N+1-th pulse by Expression 1 below.

SVb_{N+1}=−Gb×(Bn_{N}−Bt)×Kb+SVb_{N} (Expression 1)

Here, Gb represents a control gain, Bt represents a target value of the laser beam characteristic B, and Kb represents a proportional constant that indicates a ratio of a change amount of the control value SVb to a change amount of the laser beam characteristic B. By calculating the control value SVb_{N+1} for the N+1-th pulse based on a difference between the laser beam characteristic Bn_{N} and the target value Bt of the N+1-th pulse, feedback control is performed so as to bring the laser beam characteristic Bn_{N+1} of the N+1-th pulse closer to the target value Bt. The control value SVb_{N+1} obtained by the comparative example corresponds to a control value before correction in the present disclosure. The N-th pulse corresponds to a first pulse in the present disclosure, and the N+1-th pulse corresponds to a second pulse in the present disclosure.

In S80, the laser control processor 30 sets the control value SVb_{N+1} for the N+1-th pulse to the calculated value and transmits the calculated value to a corresponding adjuster. When the laser beam characteristic B is the pulse energy E, the adjuster is the power supply device 13. When the laser beam characteristic B is the wavelength λ, the adjuster is the rotation stage 14d. When the laser beam characteristic B is the spectral line width Δλ, the adjuster is the linear stage 15d.

In S90, the laser control processor 30 adds 1 to the pulse number N of the pulse laser beam and updates the value of N.

In S100, the laser control processor 30 determines whether to end the control of the laser beam characteristic B. For example, when the output of the pulse laser beam at a constant repetition frequency f is paused, the control of the laser beam characteristic B is ended. When the control of the laser beam characteristic B is to be ended (S100: YES), the laser control processor 30 ends the processing of the present flowchart. When the control of the laser beam characteristic B is not to be ended (S100: NO), the laser control processor 30 returns the processing to S40.

### 1.4 Problems of Comparative Example

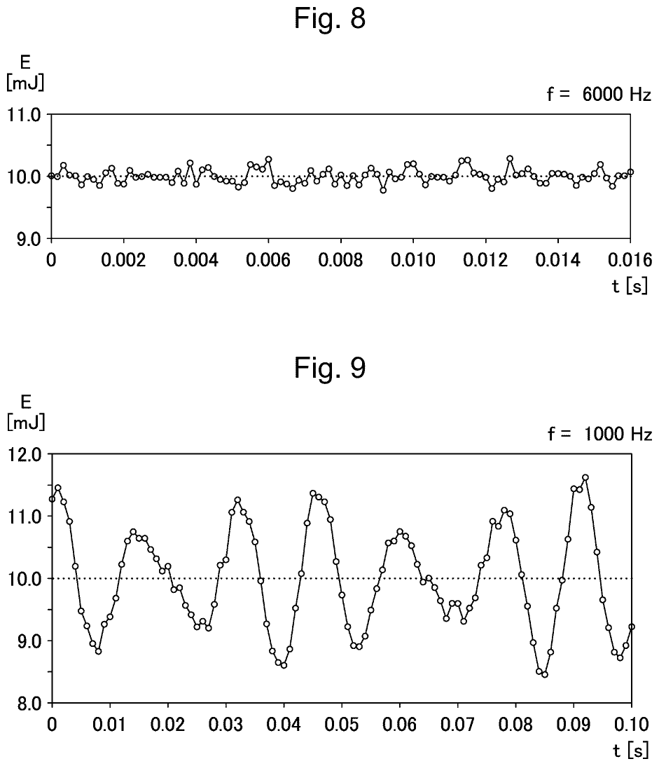

FIGS. 8 and 9 are graphs showing time-series data of the laser beam characteristic B in the comparative example. The pulse energy E is controlled as the laser beam characteristic B. The time-series data is acquired from the monitor module 17. In FIG. 8, the repetition frequency f of the pulse laser beam is 6000 Hz. In FIG. 9, the repetition frequency f is 1000 Hz. In both FIG. 8 and FIG. 9, the target value Et of the pulse energy E is 10.0 mJ. Even when the feedback control of the pulse energy E is performed by the processing shown in FIG. 7, the pulse energy E may fluctuate and deviate from the target value Et as shown in FIGS. 8 and 9. When FIGS. 8 and 9 are compared, it can be seen that how the pulse energy E fluctuates may differ depending on the repetition frequency f. As shown in FIG. 9, the fluctuation of the pulse energy E may have periodicity. When the pulse energy E fluctuates, variations in exposure performance occur in the exposure apparatus 100, which may lead to instability in the quality of a semiconductor device.

Several embodiments described below relate to stabilizing the laser beam characteristic B such as the pulse energy E more, and the laser beam characteristic B closer to the target value Bt.

### 2. Estimation of Fluctuation Causes

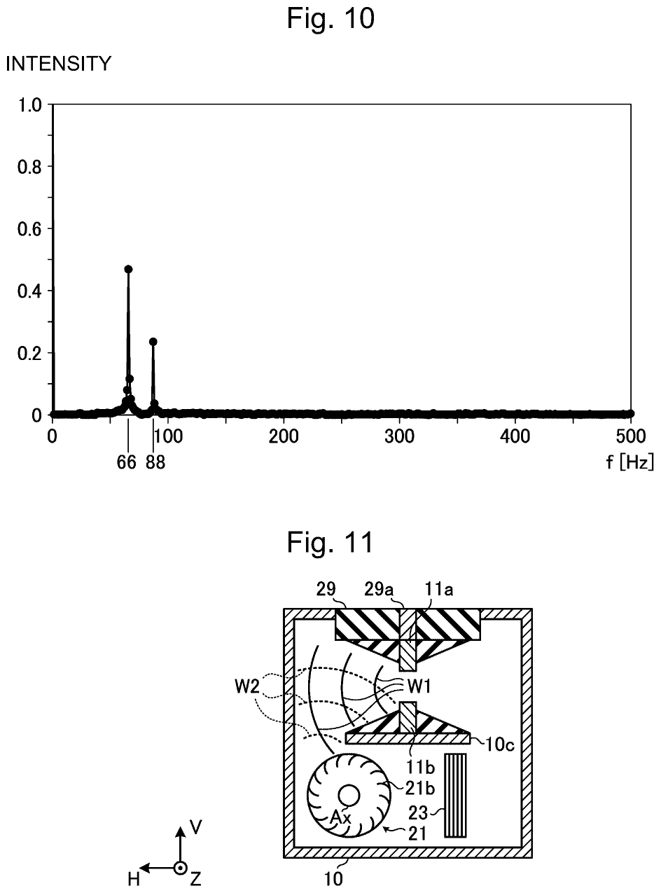

FIG. 10 is a graph showing a result of fast Fourier transform of the time-series data of the laser beam characteristic B shown in FIG. 9. From FIG. 10, it is understood that the time-series data of the laser beam characteristic B shown in FIG. 9 contains two frequency components of 66 Hz and 88 Hz in large intensities.

### 2.1 Relationship with Rotational Frequency fk

The first frequency component of 66 Hz shown in FIG. 10 substantially matches a rotational frequency fk of the crossflow fan 21. When a vibration occurs in the laser apparatus 1 due to the rotation of the crossflow fan 21, the vibration may be transmitted to various optical elements included in the laser apparatus 1, potentially causing changes in the alignment of the optical elements in synchronization with the vibration. Therefore, the frequency component of 66 Hz included in the fluctuation of the laser beam characteristic B is presumed to be due to a vibration occurring in the laser apparatus 1 synchronized with the rotation of the crossflow fan 21. The laser beam characteristic B is not limited to the pulse energy E. For example, the wavelength λ may fluctuate due to changes in the alignment of the prisms 14a and 14b or the spectral line width Δλ may fluctuate due to changes in the alignment of the cylindrical planoconcave lens 15a.

In a first embodiment, the feedforward control of the laser beam characteristic B is performed based not only on the repetition frequency f but also on the detection signal SIG indicating the rotation of the crossflow fan 21. In the first embodiment, the feedforward control of the laser beam characteristic B is performed using the rotational frequency fk.

### 2.2 Relationship with Blade Frequency fa

A product of the rotational frequency fk of the crossflow fan 21 and the number of the blades 21b is defined as a blade frequency fa. In the comparative example, the rotational frequency fk is 66 Hz, and the number of the blades 21b is 44. At this time, the blade frequency fa is 2904 Hz, and the observation frequency at the time when the frequency component of 2904 Hz is sampled at 1000 Hz that is the repetition frequency f of the pulsed laser beam is calculated to be 96 Hz. The second frequency component shown in FIG. 10, that is, 88 Hz does not completely match 96 Hz. However, considering the quantization error, the second frequency component can be regarded as corresponding to the observation frequency of the blade frequency fa.

FIG. 11 is a view for describing acoustic waves W1 and W2 generated inside the laser chamber 10. FIG. 11 corresponds to a view in which the arrows A indicating the gas flow in FIG. 3 are omitted and the acoustic waves W1 and W2 are illustrated instead. In the discharge space between the discharge electrodes 11a and 11b, discharge occurs at the repetition frequency f. In synchronization with the discharge, compressional waves of gas are generated by the excitation and heating of the gas in the discharge space. The compressional waves generated in the discharge space propagate through the space inside the laser chamber 10. The compressional waves are sometimes referred to as the acoustic waves W1. The acoustic waves W1 hit components inside the laser chamber 10 and are reflected.

When the acoustic waves W1 hit the blades 21b of the crossflow fan 21, the acoustic waves W2 reflected by the blades 21b may be affected by the blade frequency fa. When the acoustic waves W2 reach the discharge space, the density of the laser gas in the discharge space changes. Thus, the pulse energy E may fluctuate. Therefore, the frequency component of 88 Hz included in the fluctuation of the laser beam characteristic B is presumed to be due to the acoustic waves W2 reflected by the blades 21b. When the density of the laser gas in the discharge space changes, the refractive index distribution in the discharge space also changes. Thus, not only the pulse energy E but also the wavelength λ and the spectral line width Δλ may fluctuate as the laser beam characteristic B.

In a second embodiment, feedforward control of the laser beam characteristic B is performed using the blade frequency fa.

### 3. Feedforward Control Based on Repetition Frequency f and Detection Signal SIG

### 3.1 Configuration

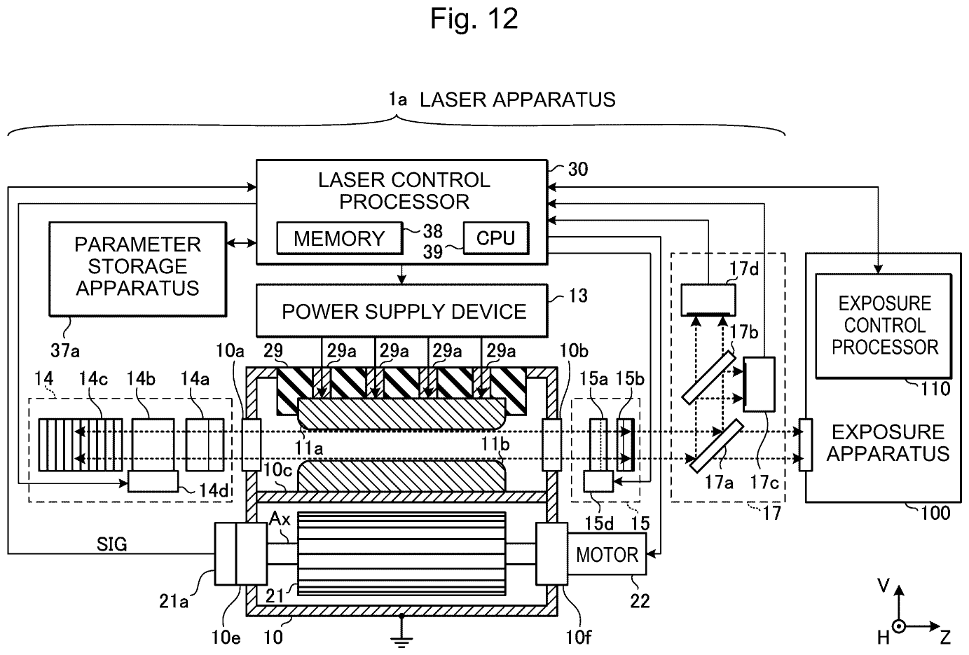

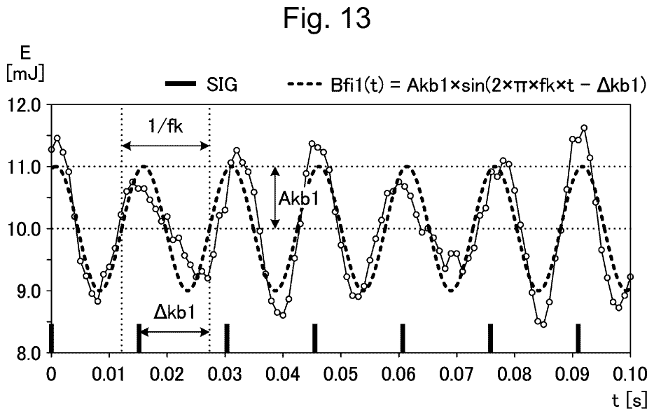

FIG. 12 schematically illustrates the configuration of the laser apparatus 1a according to the first embodiment. The laser apparatus 1a includes a parameter storage apparatus 37a. The parameter storage apparatus 37a is configured to be accessible by the laser control processor 30 and stores therein parameters to be described with reference to FIGS. 13 to 15. The parameter storage apparatus 37a may also be included in the memory 38 inside the laser control processor 30.

### 3.2 Calculation of Fluctuation Component Bfi1(t)

FIG. 13 is a graph showing the fluctuation component Bfi1(t) of the laser beam characteristic B in the first embodiment. FIG. 13 shows the time-series data of the laser beam characteristic B shown in FIG. 9 again and shows the detection signal SIG indicating the rotation of the crossflow fan 21 and the fluctuation component Bfi1(t) calculated in the first embodiment. The detection signal SIG is output from the rotation detector 21a at a period of 1/fk (see FIG. 6).

The fluctuation component Bfi1(t) is a periodic function with a period of 1/fk that is the same as the period of the detection signal SIG, and the periodic function is a sine function, for example. The fluctuation component Bfi1(t) corresponds to a first periodic function in the present disclosure, and 1/fk corresponds to a first period in the present disclosure. The fluctuation component Bfi1(t) is obtained by fitting a sine curve with a period of 1/fk to the time-series data of the laser beam characteristic B. An initial phase of the sine curve is given by a phase shift Δkb1 of the sine curve with respect to the detection signal SIG. When the result of the Fourier analysis of the time-series data is obtained as described with reference to FIG. 10, an amplitude Akb1 of the sine curve may be determined from the intensity corresponding to the rotation frequency fk of the crossflow fan 21. The amplitude Akb1 corresponds to a first amplitude in the present disclosure.

When the period 1/fk, the phase shift Δkb1, and the amplitude Akb1 are obtained as described above, the fluctuation component Bfi1(t) is given by the following expression.

Bfi1(t)=Akb1×sin(2×π×fk×t−Δkb1)

FIG. 13 shows the fluctuation component Bfi1(t) fitted to the time-series data. The position in the horizontal axis where the value of the fluctuation component Bfi1(t) becomes zero is aligned with the position of 10 mJ that is the target value Et of the pulse energy E. The fluctuation component Bfi1(t) fluctuates in synchronization with the rotation of the crossflow fan 21.

In the first embodiment, the control value SVb_{N+1} for the N+1-th pulse obtained in the comparative example (see FIG. 7) is corrected by feedforward control using the fluctuation component Bfi1(t). As a result, a corrected control value SVb1_{N+1} is calculated. The above enables control that offsets the fluctuation of the laser beam characteristic B and suppresses the deviation from the target value Bt.

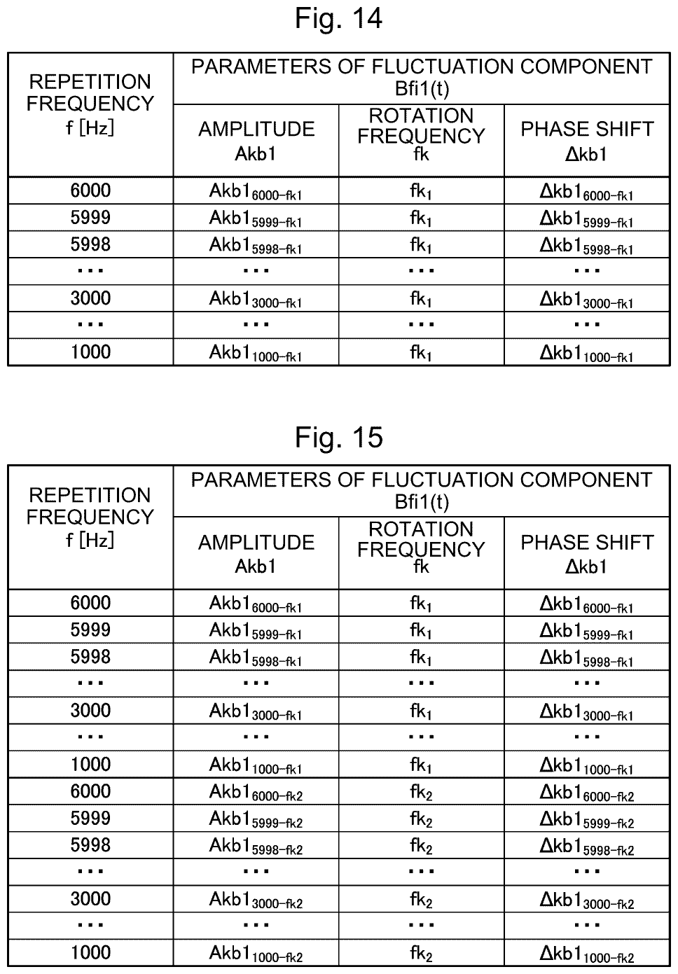

FIG. 14 shows a first example of data stored in the parameter storage apparatus 37a in the first embodiment. As described with reference to FIGS. 8 and 9, the laser beam characteristic B may differ when the repetition frequency f of the pulse laser beam is different. Therefore, a different fluctuation component Bfi1(t) is used for each repetition frequency f of the pulse laser beam. Therefore, the parameter storage apparatus 37a stores therein data that includes the correspondence relationship between the repetition frequency f and parameters including the amplitude Akb1, the rotation frequency fk, and the phase shift Δkb1. By searching the parameter storage apparatus 37a with use of the repetition frequency f, the corresponding parameters can be acquired. The rotation frequency fk of the crossflow fan 21 may be a same value fk₁ regardless of the repetition frequency f. The phase shift Δkb1 may be the same value regardless of the repetition frequency f.

FIG. 15 shows a second example of data stored in the parameter storage apparatus 37a in the first embodiment. The rotation frequency fk of the crossflow fan 21 may be set to be changeable for the purpose of reducing power consumption, for example, and different fluctuation components Bfi1(t) may be used in accordance with the change in the rotation frequency fk. Therefore, the parameter storage apparatus 37a may store therein data that includes the correspondence between the combination of the repetition frequency f and the rotation frequency fk and the parameters including the amplitude Akb1 and the phase shift Δkb1. By searching the parameter storage apparatus 37a using the repetition frequency f and the rotation frequency fk, the corresponding parameters can be acquired. In the second example, the rotation frequency fk is also one of the parameters. The rotation frequency fk is set in a range of 30 Hz or more and 95 Hz or less, for example, and is preferably 63 Hz, 66 Hz, or 75 Hz.

### 3.3 Control of Laser Beam Characteristic B

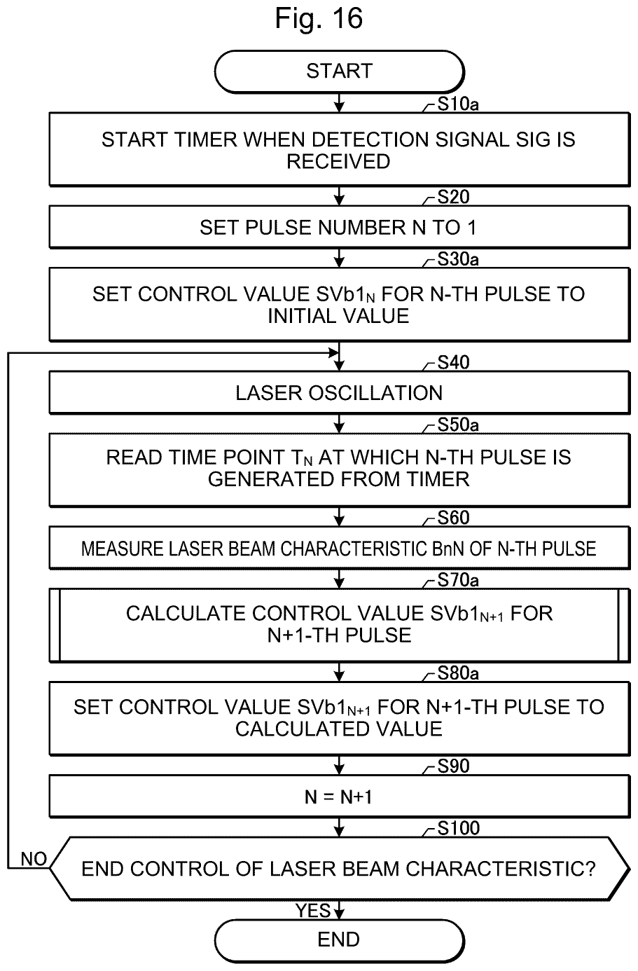

FIG. 16 is a flowchart illustrating a control procedure of the laser beam characteristic B in the first embodiment. The laser control processor 30 performs feedforward control based on the repetition frequency f and the detection signal SIG in addition to the feedback control in the comparative example (see FIG. 7) by the process as follows.

In S10a, the laser control processor 30 starts a timer when the laser control processor 30 receives the detection signal SIG. Control based on the timing of the detection signal SIG is performed by reading a time point t_{N} from the timer in S50a and calculating a time point t_{N+1} in S71a described later. Here, a case in which the timer started in S10a continues counting without being reset in the middle of the flowchart is described, but the present disclosure is not limited to the above. The timer may be reset and started each time the detection signal SIG is received.

The processing in S20, S30a, and S40 are substantially similar to those described in S20, S30, and S40 with reference to FIG. 7, respectively. In S30a, the control value is denoted as SVb1_{N} so as to be distinguished from the control value SVb_{N} in the comparative example.

In S50a, the laser control processor 30 reads the time point t_{N} at which the N-th pulse is generated from the timer. The time point t_{N} corresponds to a first time point in the present disclosure.

Processing in S60 is similar to that described with reference to FIG. 7.

In S70a, the laser control processor 30 calculates the control value SVb1_{N+1} for the N+1-th pulse as follows instead of the control value SVb_{N+1} for the N+1-th pulse described with reference to FIG. 7.

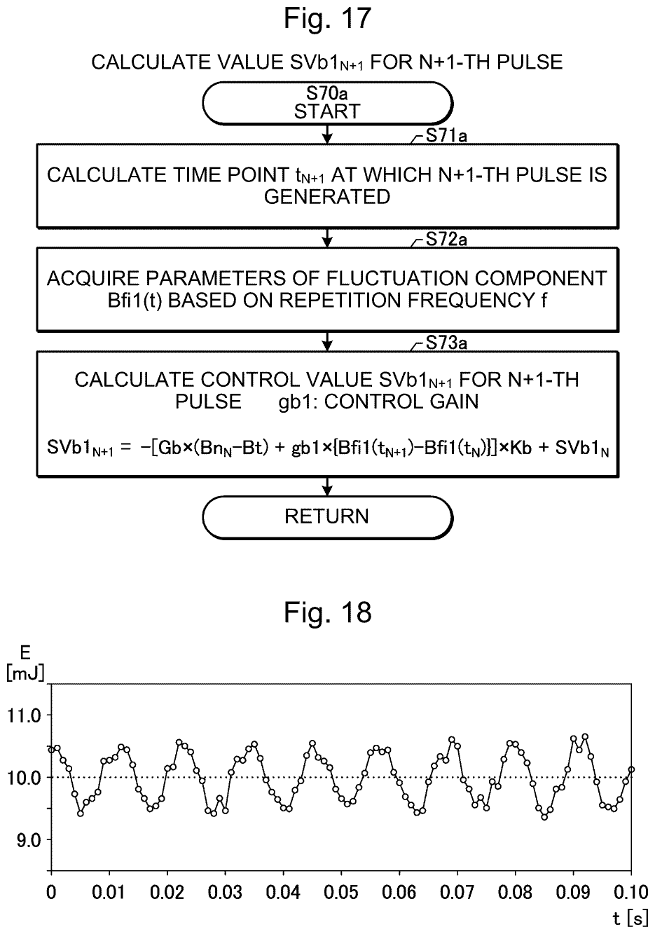

FIG. 17 is a flowchart showing the details of the processing of calculating the control value SVb1_{N+1} for the N+1-th pulse. The processing illustrated in FIG. 17 corresponds to a subroutine of S70a in FIG. 16.

In S71a, the laser control processor 30 calculates the time point t_{N+1} at which the N+1-th pulse is generated. The time point t_{N+1} is calculated by adding an inverse 1/f of the repetition frequency f to the time point t_{N} at which the N-th pulse is generated. The time point t_{N+1} corresponds to a second time point in the present disclosure.

In S72a, the laser control processor 30 acquires parameters of the fluctuation component Bfi1(t) based on the repetition frequency f. The parameters of the fluctuation component Bfi1(t) include the amplitude Akb1, the rotation frequency fk, and the phase shift Δkb1 stored in the parameter storage apparatus 37a.

In S73a, the laser control processor 30 calculates the control value SVb1_{N+1} for the N+1-th pulse by Expression 2 below.

SVb1_{N+1}=−[Gb×(Bn_{N}−Bt)+gb1×{Bfi1(t_{N+1})−Bfi1(t_{N})}]×Kb+SVb1_{N} (Expression 2)

Here, gb1 represents a control gain.

Expression 2 corresponds to an expression obtained by subtracting gb1×{Bfi1(t_{N+1})−Bfi1(t_{N})}×Kb from the right side of Expression 1 in the comparative example. In the comparative example, the control value SVb_{N+1} for the N+1-th pulse is calculated based on the difference between the laser beam characteristic Bn_{N} of the N-th pulse and the target value Bt, and hence the control value SVb_{N+1} already incorporates a first value Bfi1(t_{N}) of the fluctuation component corresponding to the time point t_{N} of the N-th pulse. Therefore, in the first embodiment, the control value SVb_{N+1} in the comparative example is corrected using the difference between a second value Bfi1(t_{N+1}) of the fluctuation component corresponding to the time point t_{N+1} of the N+1-th pulse and the first value Bfi1(t_{N}) of the fluctuation component corresponding to the time point t_{N} of the N-th pulse.

After S73a, the laser control processor 30 ends processing of the present flowchart and returns to the processing illustrated in FIG. 16.

FIG. 16 is referred to again. The processing in S80a, S90, and S100 is substantially similar to that described in S80, S90, and S100 described with reference to FIG. 7, respectively. In S80a, the control value is denoted as SVb1_{N+1} so as to be distinguished from the control value SVb_{N+1} in the comparative example.

### 3.4 Effects

(1) The laser apparatus 1a according to the first embodiment includes the laser chamber 10, the pair of discharge electrodes 11a and 11b, the crossflow fan 21, the rotation detector 21a, the adjuster such as the power supply device 13, the rotation stage 14d and the linear stage 15d, and the laser control processor 30. The discharge electrodes 11a and 11b are arranged in the laser chamber 10. The crossflow fan 21 is disposed in the laser chamber 10 and is configured to cause the laser gas in the laser chamber 10 to flow between the discharge electrodes 11a and 11b. The rotation detector 21a is configured to detect the rotation of the crossflow fan 21. The adjuster is configured to adjust the laser beam characteristic B of the pulse laser beam generated in the laser chamber 10. The laser control processor 30 is configured to correct the control value SVb_{N+1} of the adjuster based on the repetition frequency f of the pulse laser beam and the detection signal SIG of the rotation detector 21a and to control the adjuster with the corrected control value SVb1_{N+1}.

According to this, the control value SVb_{N+1} can be corrected so as to cancel the fluctuation in the laser beam characteristic B affected by the repetition frequency f and the rotation of the crossflow fan 21, and the laser beam characteristic B can be accurately controlled.

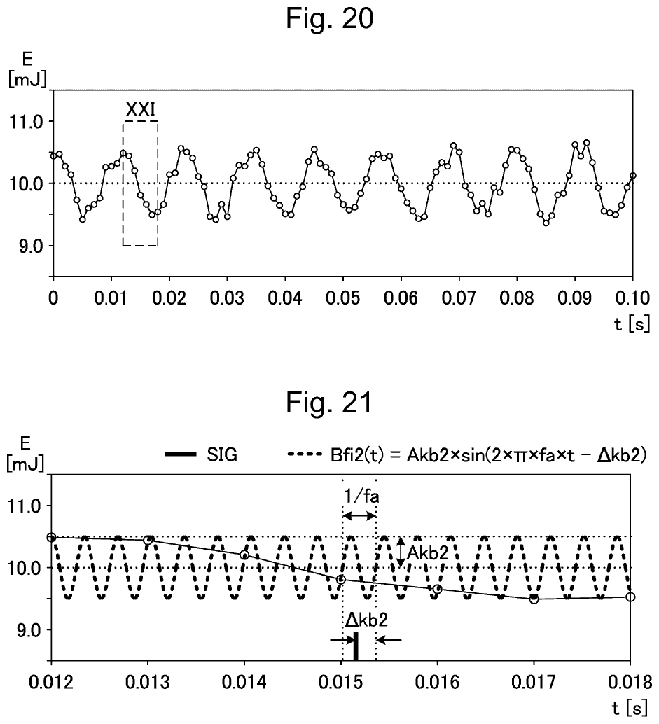

FIG. 18 is a graph showing the time-series data of the laser beam characteristic B generated using the corrected control value SVb1_{N+1} in the first embodiment. The pulse energy E is controlled as the laser beam characteristic B. FIG. 18 substantially matches a difference between the time-series data of the laser beam characteristic B in the comparative example and the fluctuation component Bfi1(t) (see FIG. 20). The repetition frequency f of the pulse laser beam is 1000 Hz, and the target value Et of the pulse energy E is 10.0 mJ. Compared to the comparative example shown in FIG. 9, the range of fluctuation of the pulse energy E is reduced, and the control accuracy of the laser beam characteristic B is improved.

(2) According to the first embodiment, the laser control processor 30 is configured to correct the control value SVb_{N+1} so as to suppress a deviation from the target value Bt of the laser beam characteristic B.

According to this, it is possible to stabilize the laser beam characteristic B by suppressing the deviation from the target value Bt.

(3) According to the first embodiment, the laser apparatus 1a includes the monitor module 17 configured to measure the laser beam characteristic B. The laser control processor 30 is configured to correct, by feedforward control based on the repetition frequency f and the detection signal SIG, the control value SVb_{N+1} set such that the laser beam characteristic Bn_{N+1} of the N+1-th pulse after the N-th pulse approaches the target value Bt by feedback control based on the difference from the target value Bt of the laser beam characteristic Bn_{N} of the N-th pulse.

According to this, the laser beam characteristic B can be accurately controlled by combining the feedback control with the feedforward control.

(4) According to the first embodiment, the laser control processor 30 is configured to calculate the fluctuation component Bfi1(t) of the laser beam characteristic B that fluctuates in synchronization with the rotation of the crossflow fan 21 and to correct the control value SVb_{N+1} with use of the fluctuation component Bfi1(t).

According to this, the fluctuation in the laser beam characteristic B caused by the rotation of the crossflow fan 21 can be suppressed by using the fluctuation component Bfi1(t) in synchronization with the rotation of the crossflow fan 21.

(5) According to the first embodiment, the laser control processor 30 corrects the control value SVb_{N+1} based on the difference between the first value Bfi1(t_{N}) of the fluctuation component corresponding to the time point t_{N} at which laser oscillation of the N-th pulse is performed and the second value Bfi1(t_{N+1}) of the fluctuation component corresponding to the time point t_{N+1} at which laser oscillation of the N+1-th pulse is performed.

According to this, the control value SVb_{N+1} by feedback control based on the difference from the target value Bt of the laser beam characteristic B of the N-th pulse can be accurately corrected by feedforward control using the difference between the fluctuation component Bfi1(t_{N}) corresponding to the N-th pulse and the fluctuation component Bfi1(t_{N+1}) corresponding to the N+1-th pulse.

(6) According to the first embodiment, the laser control processor 30 is configured to acquire the time point t_{N} by measurement and to acquire the time point t_{N+1} by calculation based on the time point t_{N} and the repetition frequency f.

According to this, the time point t_{N} is actually measured, and the time point t_{N+1} is calculated using the measured time point t_{N}. Therefore, accurate correction based on the difference between the fluctuation components Bfi1(t_{N}) and Bfi1(t_{N+1}) can be performed.

(7) According to the first embodiment, each of the time points t_{N} and t_{N+1} is defined by elapsed time based on the time at which the detection signal SIG is received.

According to this, accurate correction using the fluctuation component Bfi1(t) in synchronization with the rotation of the crossflow fan 21 can be performed by using the time at which the detection signal SIG is received as a reference.

(8) According to the first embodiment, the laser control processor 30 is configured to correct the control value SVb_{N+1} with use of the fluctuation component Bfi1(t) that is a periodic function whose period is the inverse of the rotation frequency fk of the crossflow fan 21.

The periodic fluctuation in the laser beam characteristic B caused by vibration due to the rotation of the crossflow fan 21 can be accurately suppressed by using the periodic function whose period is the inverse of the rotation frequency fk.

(9) According to the first embodiment, the laser apparatus 1a includes the monitor module 17 configured to measure the laser beam characteristic B. The laser control processor 30 is configured to acquire the time-series data of the laser beam characteristic B from the monitor module 17 and to obtain the fluctuation component Bfi1(t) by fitting a sine curve to the time-series data.

According to this, the fluctuation component Bfi1(t) can be accurately obtained by using the time-series data that is actually measured. The fluctuation component Bfi1(t) is obtained during the adjustment after the laser apparatus 1a is assembled, for example.

(10) According to the first embodiment, the laser control processor 30 is configured to obtain the amplitude Akb1 of the sine curve from the intensity corresponding to the rotational frequency fk by performing Fourier analysis on the time-series data and to fit a sine wave having the amplitude Akb1 to the time-series data.

According to this, the amplitude Akb1 of the sine wave is obtained from the Fourier analysis of the time-series data, and hence the fluctuation component Bfi1(t) can be accurately obtained.

(11) According to the first embodiment, the laser control processor 30 is configured to be accessible to the data including the correspondence relationship between the repetition frequency f and the parameter for correcting the control value SVb_{N+1}. The laser control processor 30 is configured to correct the control value SVb_{N+1} with use of the parameter acquired by searching the data with use of the repetition frequency f.

According to this, the parameter for correcting the control value SVb_{N+1} can be quickly acquired by using data created in advance.

(12) According to the first embodiment, the laser control processor 30 is configured to be accessible to the data including the correspondence relationship among the repetition frequency f, the rotational frequency fk of the crossflow fan 21, and the parameter for correcting the control value SVb_{N+1}. The laser control processor 30 is configured to correct the control value SVb_{N+1} with use of the parameter acquired by searching the data with use of the repetition frequency f and the rotational frequency fk.

According to this, fine corrections can be made by acquiring the parameter based on both the repetition frequency f and the rotational frequency fk.

Any other feature of the first embodiment is similar to that of the comparative example.

### 4. Modifications of First Embodiment

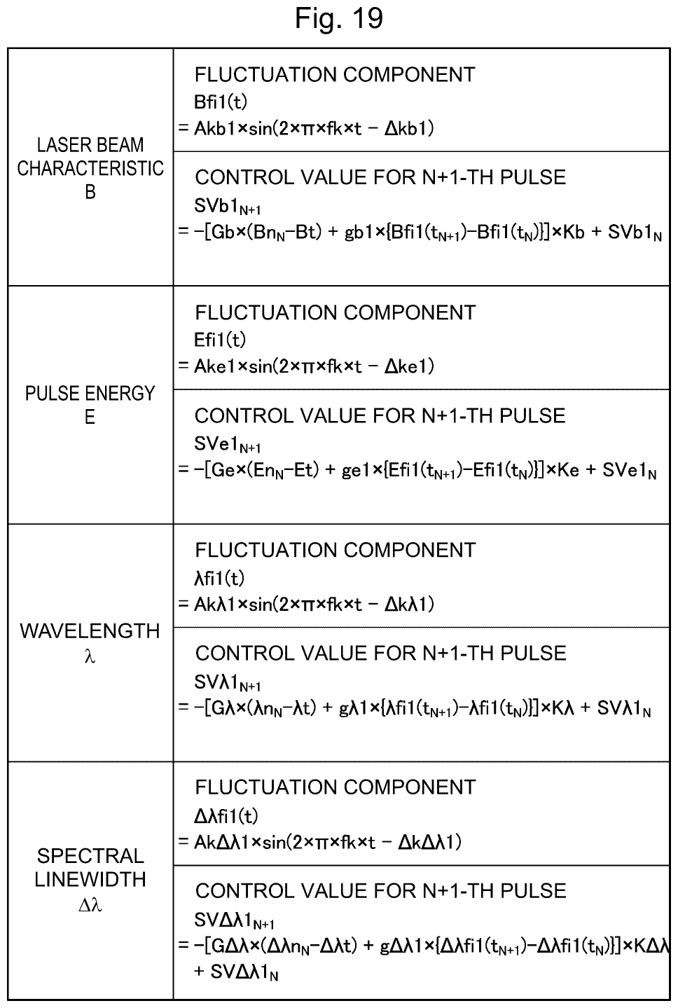

FIG. 19 shows expressions and variables that can be replaced when the pulse energy E, the wavelength λ, or the spectral line width Δλ is controlled as the laser beam characteristic B.

### 4.1 First Modification

In a first modification, the pulse energy E is controlled as the laser beam characteristic B. In this case, a fluctuation component Efi1(t) of the pulse energy E given by the following expression is used instead of the fluctuation component Bfi1(t).

Efi1(t)=Ake1×sin(2×π×fk×t−Ake1)

Here, Ake1 represents the amplitude of the fluctuation component Efi1(t).

When the pulse energy E is controlled as the laser beam characteristic B, a control value SVe1_{N+1} given by the following expression is used instead of the control value SVb1_{N+1} for the N+1-th pulse.

SVe1_{N+1}=−[Ge×(En_{N}−Et)+ge1×{Efi1(t_{N+1})−Efi1(t_{N})}]×Ke+SVe1_{N}

Here, the meanings of variables are as follows.
Ge represents a control gain of the feedback control of the pulse energy E.
En_{N} represents the pulse energy E of the N-th pulse.
Et represents a target value of the pulse energy E.
“ge1” represents a control gain of the feedforward control of the pulse energy E using the rotation frequency fk.
Efi1(t_{N+1}) and Efi1(t_{N}) represent values of the fluctuation component Efi1(t) of the pulse energy E corresponding to the time points t_{N+1} and t_{N}, respectively.
Ke represents a proportional constant that indicates a ratio of a change amount of a control value SVe1 to a change amount of the pulse energy E.

In other respects, the first modification is similar to the first embodiment.

### 4.2 Second Modification

In a second modification, the wavelength λ is controlled as the laser beam characteristic B. In this case, a fluctuation component λfi1(t) of the wavelength λ given by the following expression is used instead of the fluctuation component Bfi1(t).

λfi1(t)=Akλ1×sin(2×π×fk×t−Δkλ1)

Here, Akλ1 represents the amplitude of the fluctuation component λfi1(t).

When the wavelength λ is controlled as the laser beam characteristic B, a control value SVλ1_{N+1} given by the following expression is used instead of the control value SVb1_{N+1} for the N+1-th pulse.

SVλ1_{N+1}=−[Gλ×(λn_{N}−λt)+gλ1×{λfi1(t_{N+1})−λfi1(t_{N})}]×Kλ+SVλ1_{N}

Here, the meanings of variables are as follows.
Gλ represents a control gain of the feedback control of the wavelength λ.
λn_{N} represents the wavelength λ of the N-th pulse.
λt represents a target value of the wavelength λ.
“gλ1” represents a control gain of the feedforward control of the wavelength λ using the rotation frequency fk.
λfi1(t_{N+1}) and fi1(t_{N}) represent values of the fluctuation component λfi1(t) of the wavelength λ corresponding to the time points t_{N+1} and t_{N}, respectively.
Kλ represents a proportional constant that indicates a ratio of a change amount of a control value SVλ1 to a change amount of the wavelength λ.

In other respects, the second modification is similar to the first embodiment.

### 4.3 Third Modification

In the third modification, the spectral line width Δλ is controlled as the laser beam characteristic B. In this case, a fluctuation component Δλfi1(t) of the spectral line width Δλ given by the following expression is used instead of the fluctuation component Bfi1(t).

Δλfi1(t)=AkΔλ1×sin(2×π×fk×t−ΔkΔλ1)

Here, AkΔλ1 represents the amplitude of the fluctuation component Δλfi1(t).

When the spectral linewidth Δλ is controlled as the laser beam characteristic B, a control value SVΔλ1_{N+1} given by the following expression is used instead of the control value SVb1_{N+1} for the N+1-th pulse.

SVΔλ1_{N+1}=−[GΔλ×(Δλn_{N}−Δλt)+gΔλ1×{Δλfi1(t_{N+1})−Δλfi1(t_{N})}]×KΔλ+SVΔλ1_{N}

Here, the meanings of variables are as follows.
GΔλ represents a control gain of the feedback control of the spectral line width Δλ.
Δλn_{N} represents the spectral line width Δλ of the N-th pulse.
Δλt represents a target value of the spectral line width Δλ.
“gΔλ1” represents a control gain of the feedforward control of the spectral line width Δλ using the rotation frequency fk.
Δλfi1(t_{N+1}) and Δλfi1(t_{N}) represent values of the fluctuation component Δλfi1(t) of the spectral line width Δλ corresponding to the time points t_{N+1} and t_{N}, respectively.
KΔλ represents a proportional constant that indicates a ratio of a change amount of a control value SVΔλ1 to a change amount of the spectral line width Δλ.

In other respects, the third modification is similar to the first embodiment.

### 4.4 Fourth Modification

In a fourth modification, two or more of the pulse energy E, the wavelength λ, and the spectral line width Δλ are each controlled as the laser beam characteristic B. In this case, the variables shown in FIG. 19 are used for the control of each laser beam characteristic B. The control of each laser beam characteristic B may be independent of each other. However, the repetition frequency f, the rotation frequency fk, and the detection signal SIG may be common among different laser beam characteristics B. Common values may be used among different laser beam characteristics B regarding the phase shifts Δkb1, Δke1, Δkλ1, and ΔkΔλ1 as well.

### 4.5 Effects of Fourth Modification

(13) According to the fourth modification, the laser beam characteristic B includes a first characteristic that is one of the pulse energy E, the wavelength λ, and the spectral line width Δλ, and a second characteristic that is another one of the pulse energy E, the wavelength λ, and the spectral line width Δλ. The adjuster includes a first adjuster configured to adjust the first characteristic and a second adjuster configured to adjust the second characteristic. When the first characteristic is the pulse energy E, the first adjuster is the power supply device 13, and the second characteristic is the wavelength λ or the spectral line width Δλ. When the second characteristic is the wavelength λ, the second adjuster is the rotation stage 14d. When the second characteristic is the spectral line width Δλ, the second adjuster is the linear stage 15d. The laser control processor 30 is configured to correct both the first control value SVb_{N+1} of the first adjuster and the second control value SVb_{N+1} of the second adjuster based on the repetition frequency f and the detection signal SIG and to control the first adjuster and the second adjuster.

According to this, by applying control based on the repetition frequency f and the detection signal SIG to the plurality of laser beam characteristics B, fluctuation in the laser beam characteristics B can be efficiently suppressed.

In other respects, the fourth modification is similar to the first embodiment.

### 5. Feedforward Control Using Blade Frequency fa

The second embodiment will be described below. The configuration of the laser apparatus 1a in the second embodiment is similar to that of the first embodiment described with reference to FIG. 12.

### 5.1 Calculation of Fluctuation Component Bfi2(t)

FIG. 20 is a graph showing a difference between the time-series data of the laser beam characteristic B and the fluctuation component Bfi1(t). FIG. 20 is obtained by subtracting the fluctuation component Efi1(t_{N}) of the pulse energy E corresponding to the time point t_{N} of each pulse from the time-series data of the pulse energy E in the comparative example (see FIG. 9).

FIG. 21 is a graph showing a fluctuation component Bfi2(t) in the second embodiment. FIG. 21 shows the inside of a box line XXI in FIG. 20 in an enlarged manner and shows the detection signal SIG indicating the rotation of the crossflow fan 21 and the fluctuation component Bfi2(t) calculated in the second embodiment. The detection signal SIG is output from the rotation detector 21a at a period of 1/fk (see FIG. 6).

The fluctuation component Bfi2(t) is a periodic function whose period is an inverse 1/fa of the blade frequency fa given by the product of the rotation frequency fk of the crossflow fan 21 and the number of the blades 21b, and the periodic function is a sine function, for example. The period 1/fa of the fluctuation component Bfi2(t) is shorter than the period 1/fk of the fluctuation component Bfi1(t). The fluctuation component Bfi2(t) corresponds to a second periodic function in the present disclosure, and 1/fa corresponds to a second period in the present disclosure. The fluctuation component Bfi2(t) is obtained by fitting a sine curve having a period of 1/fa to the difference between the time-series data of the laser beam characteristic B and the fluctuation component Bfi1(t). The initial phase of the sine curve is given by a phase shift Δkb2 of the sine curve with respect to the detection signal SIG. When the result of the Fourier analysis of the time-series data is obtained as described with reference to FIG. 10, an amplitude Akb2 of the sine curve may be obtained from the intensity corresponding to the observation frequency at the time when the frequency component of the blade frequency fa is sampled at the repetition frequency f. The amplitude Akb2 corresponds to a second amplitude in the present disclosure.

As described above, when the period 1/fa, the phase shift Δkb2, and the amplitude Akb2 are obtained, the fluctuation component Bfi2(t) is given by the following expression.

Bfi2(t)=Akb2×sin(2×π×fa×t−Δkb2)

FIG. 21 shows the fluctuation component Bfi2(t) fitted to the difference between the time-series data and the fluctuation component Bfi1(t). The position in the horizontal axis where the value of the fluctuation component Bfi2(t) becomes zero is aligned with the position of 10 mJ that is the target value Et of the pulse energy E. The fluctuation component Bfi2(t) fluctuates in synchronization with the rotation of the crossflow fan 21.

In the second embodiment, the control value SVb_{N+1} for the N+1-th pulse obtained in the comparative example (see FIG. 7) is corrected by feedforward control using the fluctuation components Bfi1(t) and Bfi2(t). As a result, the corrected control value SVb2_{N+1} is calculated. The above enables control that offsets the fluctuation of the laser beam characteristic B and suppresses the deviation from the target value Bt.

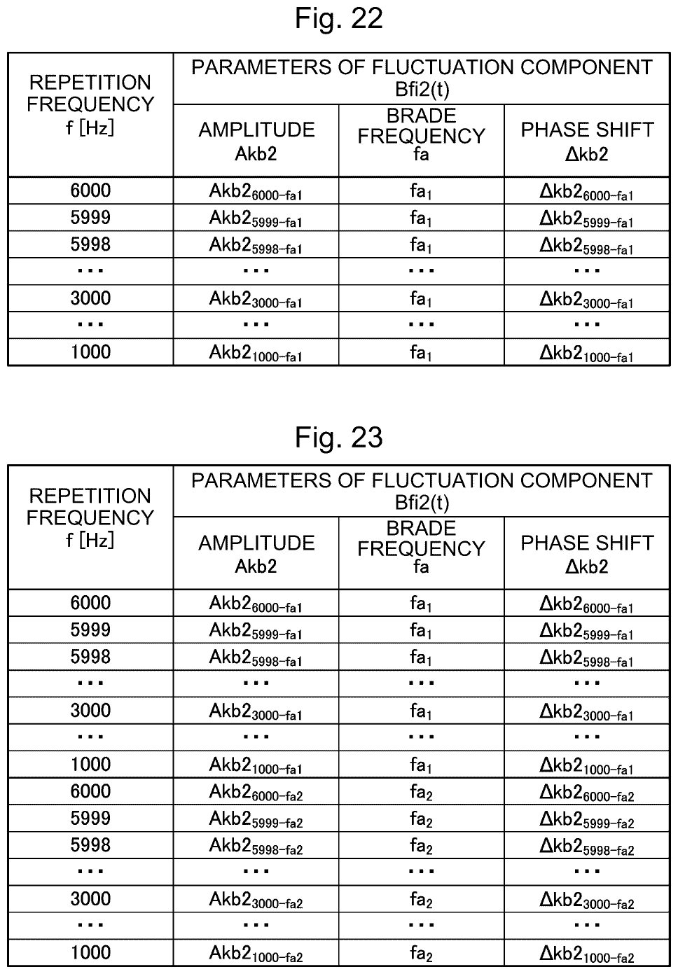

FIG. 22 shows a first example of data stored in the parameter storage apparatus 37a in the second embodiment. As described with reference to FIGS. 8 and 9, the laser beam characteristic B may differ when the repetition frequency f of the pulse laser beam is different. Therefore, a different fluctuation component Bfi2(t) is used for each repetition frequency f of the pulse laser beam. Therefore, the parameter storage apparatus 37a stores therein data that includes the correspondence relationship between the repetition frequency f and parameters including the amplitude Akb2, the blade frequency fa, and the phase shift Δkb2. By searching the parameter storage apparatus 37a with use of the repetition frequency f, the corresponding parameters can be acquired. However, the blade frequency fa may be the same value fa₁ regardless of the repetition frequency f. The phase shift Δkb2 may be the same value regardless of the repetition frequency f.

FIG. 23 shows a second example of data stored in the parameter storage apparatus 37a in the second embodiment. The rotation frequency fk of the crossflow fan 21 may be set to be changeable, and different fluctuation components Bfi2(t) may be used in accordance with the change in the blade frequency fa that accompanies the change in the rotation frequency fk. Therefore, the parameter storage apparatus 37a may store data that includes the correspondence relationship between the combination of the repetition frequency f and the blade frequency fa, and the parameters including the amplitude Akb2 and the phase shift Δkb2. By searching the parameter storage apparatus 37a with use of the repetition frequency f and the blade frequency fa, the corresponding parameters can be acquired. In the second example, the blade frequency fa is also one of the parameters. The blade frequency fa is set in a range of 1300 Hz or more and 4200 Hz or less, for example, and is preferably 2772 Hz, 2904 Hz, or 3300 Hz.

### 5.2 Control of Laser Beam Characteristic B

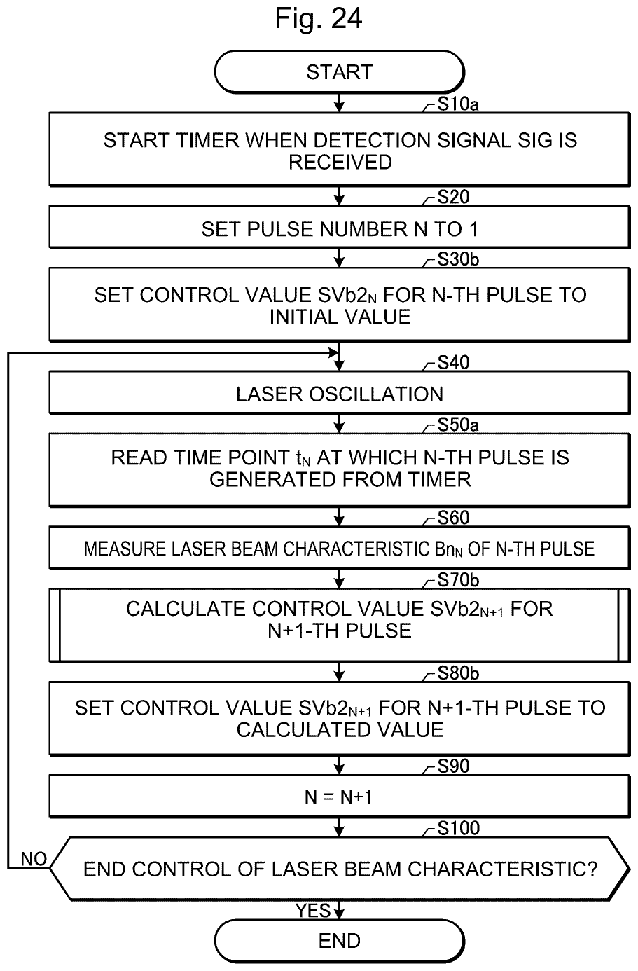

FIG. 24 is a flowchart showing a control procedure of the laser beam characteristic B in the second embodiment. The processing shown in FIG. 24 is substantially similar to that of the first embodiment described with reference to FIG. 16 except for processing of calculating the control value SVb2_{N+1} of the N+1-th pulse in S70b. In S30b, S70b, and S80b, the control values are denoted by SVb2_{N} and SVb2_{N+1} in order to be distinguished from the control values SVb1_{N} and SVb1_{N+1} in the first embodiment.

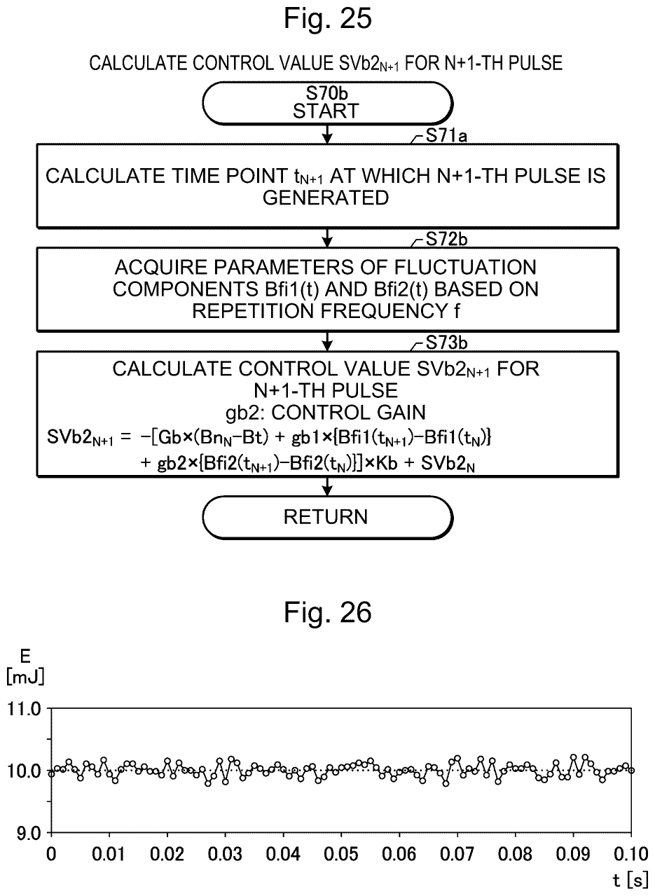

FIG. 25 is a flowchart showing details of processing of calculating the control value SVb2_{N+1} for the N+1-th pulse. The processing illustrated in FIG. 25 corresponds to a subroutine of S70b in FIG. 24.

The processing of S71a is similar to that of the first embodiment described with reference to FIG. 17.

In S72b, the laser control processor 30 acquires the parameters of the fluctuation components Bfi1(t) and Bfi2(t) based on the repetition frequency f. The parameters of the fluctuation component Bfi1(t) include the amplitude Akb1, the rotation frequency fk, and the phase shift Δkb1 shown in FIG. 14 or FIG. 15. The parameters of the fluctuation component Bfi2(t) include the amplitude Akb2, the blade frequency fa, and the phase shift Δkb2 shown in FIG. 22 or FIG. 23.

In S73b, the laser control processor 30 calculates the control value SVb2_{N+1} of the N+1-th pulse by Expression 3 below.

SVb2_{N+1}=−[Gb×(Bn_{N}−Bt)+gb1×{Bfi1(t_{N+1})−Bfi1(t_{N})}+gb2×{Bfi2(t_{N+1})−Bfi2(t_{N})}]×Kb+SVb2_{N} (Expression 3)

Here, gb2 represents a control gain.

Expression 3 corresponds to an expression obtained by subtracting [gb1×{Bfi1(t_{N+1})−Bfi1(t_{N})}+gb2×{Bfi2(t_{N+1})−Bfi2(t_{N})}]×Kb from the right side of Expression 1 in the comparative example. In the comparative example, the control value SVb_{N+1} for the N+1-th pulse is calculated based on the difference between the laser beam characteristic Bn_{N} of the N-th pulse and the target value Bt, and hence the control value SVb_{N+1} already incorporates the first value Bfi1(t_{N}) and a first value Bfi2(t_{N}) of the fluctuation component corresponding to the time point t_{N} of the N-th pulse. Therefore, in the second embodiment, the control value SVb_{N+1} in the comparative example is corrected with use of the difference between the second value Bfi1(t_{N+1}) of the fluctuation component corresponding to the time point t_{N+1} of the N+1-th pulse and the first value Bfi1(t_{N}) of the fluctuation component corresponding to the time point t_{N} of the N-th pulse, and the difference between the second value Bfi2(t_{N+1}) of the fluctuation component corresponding to the time point t_{N+1} of the N+1-th pulse and the first value Bfi2(t_{N}) of the fluctuation component corresponding to the time point t_{N} of the N-th pulse.

After S73b, the laser control processor 30 ends processing of the present flowchart and returns to the processing illustrated in FIG. 24.

### 5.3 Effects

(14) According to the second embodiment, the crossflow fan 21 includes the blades 21b arranged around the rotation shaft Ax. The laser control processor 30 is configured to correct the control value SVb_{N+1} with use of the fluctuation component Bfi2(t) that is a periodic function whose period is an inverse of the blade frequency fa defined as a product of the rotation frequency fk of the crossflow fan 21 and the number of the blades 21b.

According to this, it is possible to make corrections that take the influence of the acoustic waves W2 reflected by the blades 21b into account by using the product of the rotation frequency fk of the crossflow fan 21 and the number of the blades 21b.

FIG. 26 is a graph showing the time-series data of the laser beam characteristic B generated using the corrected control value SVb2_{N+1} in the second embodiment. The pulse energy E is controlled as the laser beam characteristic B. FIG. 26 substantially matches the difference between the time-series data of the laser beam characteristic B in the comparative example and the sum of the fluctuation components Bfi1(t) and Bfi2(t). The repetition frequency f of the pulse laser beam is 1000 Hz, and the target value Et of the pulse energy E is 10.0 mJ. Compared to the first embodiment shown in FIG. 18, the range of fluctuation of the pulse energy E is reduced and is stabilized near the target value Et.

Feedforward control is not limited to control using both of the fluctuation components Bfi1(t) and Bfi2(t) and control using only the fluctuation component Bfi2(t) is also possible. When only the fluctuation component Bfi2(t) is used, the fluctuation of the laser beam characteristic B of the pulse laser beam approximately matches the difference between the time-series data of the laser beam characteristic B in the comparative example and the fluctuation component Bfi2(t).

(15) According to the second embodiment, the laser control processor 30 is configured to correct the control value SVb_{N+1} with use of the fluctuation component Bfi1(t) that is a periodic function having a period of 1/fk and in synchronization with the rotation of the crossflow fan 21, and the fluctuation component Bfi2(t) that is a periodic function having a period of 1/fa shorter than 1/fk and in synchronization with the rotation of the crossflow fan 21.

According to this, even when the fluctuation of the laser beam characteristic B includes two frequency components, it is possible to accurately correct the control value SVb_{N+1} by using the fluctuation components Bfi1(t) and Bfi2(t) with different periods.

(16) According to the second embodiment, the crossflow fan 21 includes the blades 21b arranged around the rotation shaft Ax. The laser control processor 30 is configured to correct the control value SVb_{N+1} with use of the fluctuation component Bfi1(t) that is a periodic function whose period is an inverse of the rotation frequency fk of the crossflow fan 21 and the fluctuation component Bfi2(t) that is a periodic function whose period is an inverse of a product of the rotation frequency fk of the crossflow fan 21 and the number of the blades 21b.

According to this, it is possible to perform corrections that take the influence of both the vibration caused by the rotation of the crossflow fan 21 and the acoustic waves W2 reflected by the blades 21b into account.

(17) According to the second embodiment, the laser apparatus 1a includes the monitor module 17 configured to measure the laser beam characteristic B. The laser control processor 30 is configured to acquire the time-series data of the laser beam characteristic B from the monitor module 17. The laser control processor 30 is configured to obtain the fluctuation component Bfi1(t) by fitting the first sine wave to the time-series data and to obtains the fluctuation component Bfi2(t) by fitting the second sine wave to the difference between the time-series data and the fluctuation component Bfi1(t).

According to this, it is possible to accurately obtain the fluctuation component Bfi2(t) excluding the correction amount due to the fluctuation component Bfi1(t) by using the difference between the time-series data and the fluctuation component Bfi1(t).

(18) According to the second embodiment, the laser control processor 30 is configured to perform Fourier analysis on the time-series data to obtain the amplitude Akb1 of the first sine wave from the first intensity corresponding to the rotation frequency fk and to obtain the amplitude Akb2 of the second sine wave from the second intensity corresponding to the observation frequency at the time when the frequency component of the blade frequency fa is sampled at the repetition frequency f. The laser control processor 30 is configured to fit the first sine wave having the amplitude Akb1 to the time-series data and to fit the second sine wave having the amplitude Akb2 to the difference between the time-series data and the fluctuation component Bfi1(t).

According to this, the amplitudes Akb1 and Akb2 of the sine wave are obtained from the Fourier analysis of the time-series data, and hence the fluctuation components Bfi1(t) and Bfi2(t) can be accurately obtained.

In other respects, the second embodiment is similar to the first embodiment.

### 6. Modifications of Second Embodiment

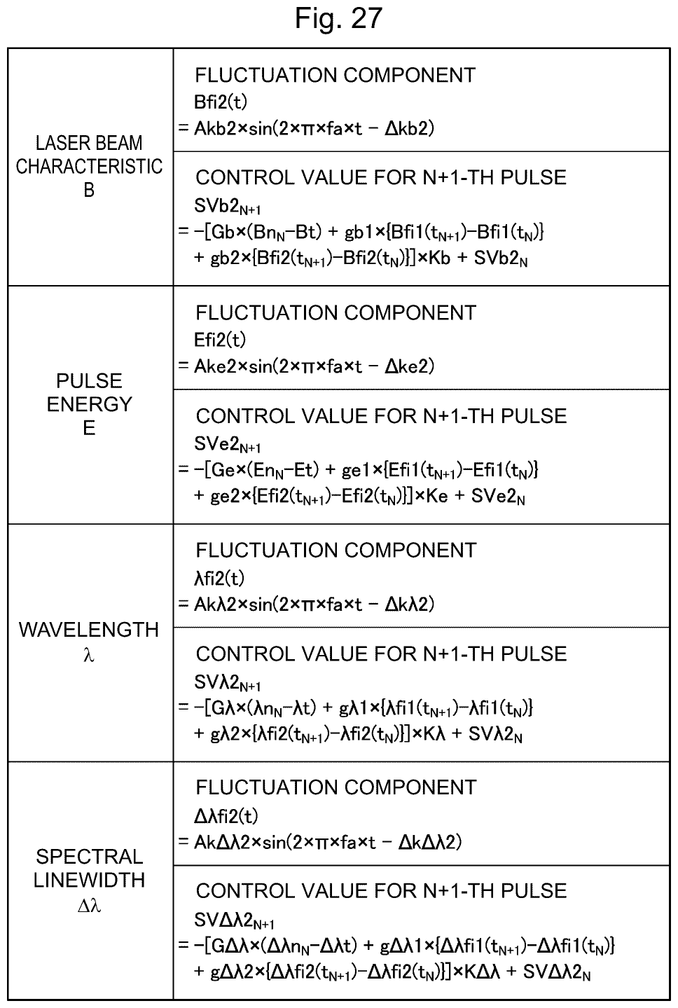

FIG. 27 shows expressions and variables that can be replaced when the pulse energy E, the wavelength λ, or the spectral line width Δλ is controlled as the laser beam characteristic B.

### 6.1 First Modification

In a first modification, the pulse energy E is controlled as the laser beam characteristic B. In this case, a fluctuation component Efi2(t) of the pulse energy E given by the following expression is used instead of the fluctuation component Bfi2(t).

Efi2(t)=Ake2×sin(2×π×fa×t−Δke2)

Here, Ake2 represents an amplitude of the fluctuation component Efi2(t).

When the pulse energy E is controlled as the laser beam characteristic B, a control value SVe2_{N+1} given by the following expression is used instead of the control value SVb2_{N+1} for the N+1-th pulse.

SVe2_{N+1}=−[Ge×(En_{N}−Et)+ge1×{Efi1(t_{N+1})−Efi1(t_{N})}+ge2×{Efi2(t_{N+1})−Efi2(t_{N})}]×Ke+SVe2_{N}

Here, the meanings of variables are as follows.
“ge2” represents a control gain of the feedforward control of the pulse energy E using the blade frequency fa.
Efi2 (t_{N+1}) and Efi2 (t_{N}) represent values of the fluctuation component Efi2(t) of the pulse energy E corresponding to the time points t_{N+1} and t_{N}, respectively.

In other respects, the first modification is similar to the second embodiment.

### 6.2 Second Modification

In a second modification, the wavelength λ is controlled as the laser beam characteristic B. In this case, a fluctuation component λfi2(t) of the wavelength λ given by the following expression is used instead of the fluctuation component Bfi2(t).

λfi2(t)=Akλ2×sin(2×π×fa×t−Δkλ2)

Here, Akλ2 represents the amplitude of the fluctuation component λfi2(t).

When the wavelength λ is controlled as the laser beam characteristic B, a control value SVλ2_{N+1} given by the following expression is used instead of the control value SVb2_{N+1} for the N+1-th pulse.

SVλ2_{N+1}=−[Gλ×(λn_{N}−λt)+gλ1×{λfi1(t_{N+1})−λfi1(t_{N})}+gλ2×{λfi2(t_{N+1})−λfi2(t_{N})}]×Kλ+SVλ2_{N}

Here, the meanings of variables are as follows.
“gλ2” represents a control gain of the feedforward control of the wavelength λ using the blade frequency fa.
λfi2 (t_{N+1}) and λfi2 (t_{N}) represent values of the fluctuation component λfi2(t) of the wavelength λ corresponding to the time points t_{N+1} and t_{N}, respectively.

In other respects, the second modification is similar to the second embodiment.

### 6.3 Third Modification

In a third modification, the spectral line width Δλ is controlled as the laser beam characteristic B. In this case, a fluctuation component Δλfi2(t) of the spectral line width Δλ given by the following expression is used instead of the fluctuation component Bfi2(t).

Δλfi2(t)=AkΔλ2×sin(2×π×fa×t−ΔkΔλ2)

Here, AkΔλ2 represents the amplitude of the fluctuation component Δλfi2(t).

When the spectral line width Δλ is controlled as the laser beam characteristic B, a control value SVΔλ2_{N+1} given by the following expression is used instead of the control value SVb2_{N+1} for the N+1-th pulse.

SVΔλ2_{N+1}=−[GΔλ×(Δλn_{N}−Δλt)+gΔλ1×{Δλfi1(t_{N+1})−Δλfi1(t_{N})}+gΔλ2×{Δλfi2(t_{N+1})−Δλfi2(t_{N})}]×KΔλ+SVΔλ2_{N}

Here, the meanings of variables are as follows.
“gΔλ2” represents a control gain of the feedforward control of the spectral line width Δλ using the blade frequency fa.
Δλfi2 (t_{N+1}) and Δλfi2 (t_{N}) represent values of the fluctuation component Δλfi2(t) of the spectral line width Δλ corresponding to the time points t_{N+1} and t_{N}, respectively.

In other respects, the third modification is similar to the second embodiment.

### 6.4 Fourth Modification

In a fourth modification, two or more of the pulse energy E, the wavelength λ, and the spectral line width Δλ are each controlled as the laser beam characteristics B. In this case, the variables shown in FIGS. 19 and 27 are used for the control of each laser beam characteristic B. The control of each laser beam characteristic B may be independent of each other. However, the repetition frequency f, the rotation frequency fk, the blade frequency fa, and the detection signal SIG may be common among different laser beam characteristics B. Common values may be used among different laser beam characteristics B regarding the phase shifts Δkb1, Δke1, Δkλ1, ΔkΔλ1, Δkb2, Δke2, Δkλ2, and ΔkΔλ2 as well.

In other respects, the fourth modification is similar to the second embodiment.

### 7. Others

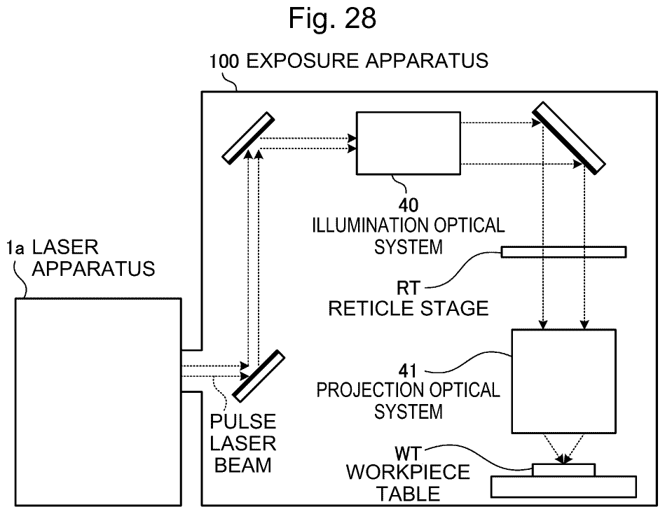

FIG. 28 schematically shows the configuration of the exposure apparatus 100 connected to the laser apparatus 1a. The laser apparatus 1a generates a pulse laser beam and outputs the pulse laser beam to the exposure apparatus 100.

In FIG. 28, the exposure apparatus 100 includes an illumination optical system 40 and a projection optical system 41. The illumination optical system 40 illuminates the reticle pattern of a non-illustrated reticle disposed on a reticle stage RT with the pulse laser beam incident from the laser apparatus 1a. The pulse laser beam having transmitted through the reticle is imaged on a non-illustrated workpiece disposed on a workpiece table WT by reduced projection through the projection optical system 41. The workpiece is a photosensitive substrate such as a semiconductor wafer to which photoresist is applied. The exposure apparatus 100 translates the reticle stage RT and the workpiece table WT in synchronization so that the workpiece is exposed to the pulse laser beam on which the reticle pattern is reflected. An electronic device can be manufactured through a plurality of processes after the reticle pattern is transferred onto the semiconductor wafer through the exposure process as described above.

The description above is intended to be illustrative and the present disclosure is not limited thereto. Therefore, it would be obvious to those skilled in the art that various modifications to the embodiments of the present disclosure would be possible without departing from the scope of the claims. Further, it would be also obvious for those skilled in the art that embodiments of the present disclosure would be appropriately combined.

The terms used throughout the present specification and the claims should be interpreted as non-limiting terms unless clearly described. For example, terms such as “comprise”, “include”, “have”, and “contain” should not be interpreted to be exclusive of other structural elements. When wording “X has Y” is used, this should be interpreted such that what X has is not limited to Y. Further, indefinite articles “a/an” described in the present specification and the appended claims should be interpreted to mean “at least one” or “one or more”. Further, “at least one of A, B, and C” should be interpreted to mean any of A, B, C, A+B, A+C, B+C, and A+B+C as well as to include combinations of any thereof and any other than A, B, and C.

What is claimed is:

1. A laser apparatus, comprising:
a laser chamber;
a pair of discharge electrodes disposed in the laser chamber;
a fan disposed in the laser chamber and configured to cause laser gas in the laser chamber to flow between the discharge electrodes;
a rotation detector configured to detect rotation of the fan;
an adjuster configured to adjust a laser beam characteristic of a pulse laser beam generated in the laser chamber; and
a processor configured to correct a control value of the adjuster based on a repetition frequency of the pulse laser beam and a detection signal of the rotation detector and to control the adjuster with the corrected control value.

2. The laser apparatus according to claim 1, wherein the processor is configured to correct the control value so as to suppress deviation from a target value of the laser beam characteristic.

3. The laser apparatus according to claim 1, further comprising a laser beam detector configured to measure the laser beam characteristic, wherein the processor is configured to correct, by feedforward control based on the repetition frequency and the detection signal, the control value set such that the laser beam characteristic of a second pulse after a first pulse of the pulse laser beam approaches a target value by feedback control based on a difference from the target value of the laser beam characteristic of the first pulse of the pulse laser beam.

4. The laser apparatus according to claim 3, wherein the processor is configured to calculate a fluctuation component of the laser beam characteristic and to correct the control value using the fluctuation component, the fluctuation component fluctuating in synchronization with rotation of the fan.

5. The laser apparatus according to claim 4, wherein the processor is configured to correct the control value based on a difference between a first value of the fluctuation component corresponding to a first time point at which laser oscillation of the first pulse is performed and a second value of the fluctuation component corresponding to a second time point at which laser oscillation of the second pulse is performed.

6. The laser apparatus according to claim 5, wherein the processor is configured to acquire the first time point by measurement and to acquire the second time point by calculation based on the first time point and the repetition frequency.

7. The laser apparatus according to claim 5, wherein each of the first time point and the second time point is defined by elapsed time based on time at which the detection signal is received.

8. The laser apparatus according to claim 1, wherein the processor is configured to correct the control value using a periodic function whose period is an inverse of a rotation frequency of the fan.

9. The laser apparatus according to claim 8, further comprising a laser beam detector configured to measure the laser beam characteristic, wherein the processor is configured to:
acquire time-series data of the laser beam characteristic from the laser beam detector; and
obtain the periodic function by fitting a sine curve to the time-series data.

10. The laser apparatus according to claim 9, wherein the processor is configured to:
obtain an amplitude of the sine curve from an intensity corresponding to the rotation frequency by performing Fourier analysis on the time-series data; and
fit the sine curve having the amplitude to the time-series data.

11. The laser apparatus according to claim 1, wherein the processor is configured to:
be accessible to data including correspondence relationship between the repetition frequency and a parameter for correcting the control value; and
correct the control value with use of the parameter acquired by searching the data with use of the repetition frequency.

12. The laser apparatus according to claim 1, wherein the processor is configured to:
be accessible to data including correspondence relationship between the repetition frequency, a rotation frequency of the fan, and a parameter for correcting the control value; and
correct the control value with use of the parameter acquired by searching the data with use of the repetition frequency and the rotation frequency.

13. The laser apparatus according to claim 1, wherein:
the laser beam characteristic includes a first characteristic that is one of a pulse energy, a wavelength, and a spectral line width, and a second characteristic that is another one of the pulse energy, the wavelength, and the spectral line width;
the adjuster includes a first adjuster configured to adjust the first characteristic and a second adjuster configured to adjust the second characteristic; and
the processor is configured to control the first adjuster and the second adjuster by correcting both a first control value of the first adjuster and a second control value of the second adjuster based on the repetition frequency and the detection signal.

14. The laser apparatus according to claim 1, wherein:
the fan includes a plurality of blades disposed around a rotation shaft; and
the processor is configured to correct the control value with use of a periodic function whose period is an inverse of a blade frequency given by a product of a rotation frequency of the fan and a number of the blades.

15. The laser apparatus according to claim 1, wherein the processor is configured to correct the control value with use of a first periodic function that has a first period and that is synchronized with the rotation of the fan and a second periodic function that has a second period shorter than the first period and that is synchronized with the rotation of the fan.

16. The laser apparatus according to claim 1, wherein:
the fan includes a plurality of blades disposed around a rotation shaft; and
the processor is configured to correct the control value with use of a first periodic function whose period is an inverse of a rotation frequency of the fan and a second periodic function whose period is an inverse of a blade frequency given by a product of the rotation frequency and a number of the blades.

17. The laser apparatus according to claim 16, further comprising a laser beam detector configured to measure the laser beam characteristic, wherein the processor is configured to:
acquire time-series data of the laser beam characteristic from the laser beam detector;
obtain the first periodic function by fitting a first sine curve to the time-series data; and
obtain the second periodic function by fitting a second sine curve to a difference between the time-series data and the first periodic function.

18. The laser apparatus according to claim 17, wherein the processor is configured to:
perform Fourier analysis on the time-series data to obtain a first amplitude of the first sine curve from a first intensity corresponding to the rotation frequency and obtain a second amplitude of the second sine curve from a second intensity corresponding to an observation frequency at time when a frequency component of the blade frequency is sampled at the repetition frequency;
fit the first sine curve having the first amplitude to the time-series data; and
fit the second sine curve having the second amplitude to the difference.

19. A method of controlling a laser apparatus, the laser apparatus including:
a laser chamber;
a pair of discharge electrodes disposed in the laser chamber;
a fan disposed in the laser chamber and configured to cause laser gas in the laser chamber to flow between the discharge electrodes;
a rotation detector configured to detect rotation of the fan; and
an adjuster configured to adjust a laser beam characteristic of a pulse laser beam generated in the laser chamber,
the method comprising:
correcting a control value of the adjuster based on a repetition frequency of the pulse laser beam and a detection signal of the rotation detector; and
controlling the adjuster with the corrected control value.

20. A method of manufacturing an electronic device comprising:
generating a pulse laser beam with a laser apparatus, the laser apparatus including:
a laser chamber;
a pair of discharge electrodes disposed in the laser chamber;
a fan disposed in the laser chamber and configured to cause laser gas in the laser chamber to flow between the discharge electrodes;
a rotation detector configured to detect rotation of the fan;
an adjuster configured to adjust a laser beam characteristic of the pulse laser beam generated in the laser chamber; and
a processor configured to correct a control value of the adjuster based on a repetition frequency of the pulse laser beam and a detection signal of the rotation detector and to control the adjuster with the corrected control value;
outputting the pulse laser beam to an exposure apparatus; and
exposing a photosensitive substrate to the pulse laser beam in the exposure apparatus to manufacture the electronic device.
